(19) United States
(12) Patent Application Publication
(10) Pub. No.: US 2010/0045727 A1
(43) Pub. Date: Feb. 25, 2010

(54) LIQUID EJECTING APPARATUS AND LIQUID EJECTING METHOD

(75) Inventor: Naoki Kayahara, Chino-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/546,598

(22) Filed: Aug. 24, 2009

(30) Foreign Application Priority Data
Aug. 25, 2008 (JP) 2008-215693

(51) Int. Cl. B41J 29/38; B41J 2/01

(52) U.S. Cl. 347/16; 347/104

(57) ABSTRACT

A liquid ejecting apparatus includes: a head that ejects a liquid on a medium positioned in a printable area; a transporting unit that transports a first medium and a second medium successively in a transport direction; a first supporting member that supports a transport-direction upstream side end portion of the first medium and moves in the transport direction according to transportation of the first medium; and a second supporting member that supports a transport-direction downstream side end portion of the second medium and moves in the transport direction according to transportation of the second medium.

This application claims priority to Japanese Patent Application No. 2008-215693, filed Aug. 25, 2008, the entirety of which is incorporated by reference herein.

### BACKGROUND

1. Technical Field

The present invention relates to a liquid ejecting apparatus and a liquid ejecting method.

2. Related Art

Liquid ejecting apparatuses (for example, an ink jet printer) for printing an image by ejecting a liquid (for example, an ink) on a medium (for example, a paper, a cloth, or a film) have been known (for example, refer to Patent Document JP-A-2005-205691). In the liquid ejecting apparatuses, printing media are sequentially transported to a printable area, and printing is performed medium-by-medium.

In general, as described above, the printing is performed medium-by-medium. More specifically, a first medium is transported to the printable area, and the printing is performed. After the printing on the first medium is ended (that is, after the first medium is discharged), the next medium is transported to the printable area, and the printing on the next medium starts. In this manner, since two media are not successively printed, a long printing time is taken.

### SUMMARY

An advantage of some aspects of the invention is to reduce a printing time.

According to an aspect of the invention, there is provided a liquid ejecting apparatus comprising: a head that ejects a liquid on a medium positioned in a printable area; a transporting unit that transports a first medium and a second medium successively in a transport direction; a first supporting member that supports a transport-direction upstream side end portion of the first medium and moves in the transport direction according to transportation of the first medium; and a second supporting member that supports a transport-direction downstream side end portion of the second medium and moves in the transport direction according to transportation of the second medium.

Other features of the invention will be clarified by the specification and the accompanying drawings.

### BRIEF DESCRIPTION OF THE DRAWINGS

The invention will be described with reference to the accompanying drawings, wherein like numbers reference like elements.

FIG. 1 is a block diagram illustrating a whole configuration of a printer.

FIG. 2A is a schematic view illustrating a printer, and FIG. 2B is a transverse cross-sectional view of the printer.

FIG. 3 is a view for explaining a head.

FIGS. 4A to 4D are views for explaining a printing method according to a comparative example.

FIG. 5A is a perspective view illustrating a platen according to a first embodiment, and FIG. 5B is a side view illustrating the platen according to the first embodiment.

FIG. 6 is a view illustrating a driving method for a first rib and a second rib.

FIGS. 7A to 7H are views for explaining a printing method according to the first embodiment.

FIG. 8A is a perspective view illustrating a platen according to a second embodiment, and FIG. 8B is a view for explaining a driving method for ribs according to the second embodiment.

FIGS. 9A to 9H are views for explaining a printing method according to the second embodiment.

FIG. 10 is a view for explaining an example of a configuration of a platen 24 according to a third embodiment.

FIGS. 11A to 11F are views for explaining a printing method according to the third embodiment.

FIG. 12 is a block diagram illustrating a whole configuration of a printer according to a fourth embodiment.

FIG. 13 is a transverse cross-sectional view illustrating the printer according to the fourth embodiment.

FIG. 14 is a view for explaining an array of a plurality of nozzle columns on a lower surface of a head according to the fourth embodiment, as viewed in perspective from an upper side.

FIGS. 15A to 15F are views for explaining a printing method according to the fourth embodiment.

FIG. 16 is a view for explaining an array of a plurality of nozzle columns on a lower surface of a head according to the fifth embodiment, as viewed in perspective from an upper side.

### DESCRIPTION OF EXEMPLARY EMBODIMENTS

The following description will be clarified by the specification and the accompanying drawings.

A liquid ejecting apparatus includes: a head that ejects a liquid on a medium positioned in a printable area; a transporting unit that transports a first medium and a second medium successively in a transport direction; a first supporting member that supports a transport-direction upstream side end portion of the first medium and moves in the transport direction according to transportation of the first medium; and a second supporting member that supports a transport-direction downstream side end portion of the second medium and moves in the transport direction according to transportation of the second medium.

According to the liquid ejecting apparatus, the printing can be performed in the state where the transport-direction upstream side end portion of the first medium and the transport-direction downstream side end portion of the second medium reach each other as close as possible. Accordingly, a printing time can be reduced.

In the liquid ejecting apparatus, the first supporting member may support the first medium, and the second supporting member may support the second medium.

According to the liquid ejecting apparatus, the first medium and the second medium can be successively printed.

The liquid ejecting apparatus may further include a detecting unit that detects an end portion of each medium, in which the transport-direction downstream side end portion of the second medium is detected by the detecting unit during the printing for the first medium.

According to the liquid ejecting apparatus, just after the printing for the first medium is completed, the second medium can be transported to the printable area.

In the liquid ejecting apparatus, the transporting unit may include: a first roller that transports the medium at the transport-direction downstream side with respect to the printable area; and a second roller that transports the medium at the transport-direction upstream side with respect to the printable area. When the first supporting member supports the transport-direction upstream side end portion of the first medium and when the second supporting member supports the transport-direction downstream side end portion of the second medium, the first medium may be transported by the first roller, and the second medium may be transported by the second roller.

According to the liquid ejecting apparatus, the first medium and the second medium can be transported in the state where the first medium and the second medium reach each other as close as possible.

In the liquid ejecting apparatus, while the second supporting member supports the second medium, the first supporting member may move to the transport-direction upstream side.

According to the liquid ejecting apparatus, the supporting members can be moved to the transport-direction upstream side without losing postures of the media.

In the liquid ejecting apparatus, when the head does not eject the liquid, the first supporting member may move to the transport-direction upstream side to support the second medium.

According to the liquid ejecting apparatus, the first supporting member can be moved to the transport-direction upstream side without contaminating the first supporting member with the liquid.

In the liquid ejecting apparatus, the head may include a first nozzle and a second nozzle that is disposed at the transport-direction upstream side with respect to the first nozzle, and when the head forms dots on the transport-direction upstream side end portion of the first medium by using the first nozzle, the transport-direction downstream side end portion of the second medium may be positioned in the printable area, and the head may form dots on the transport-direction downstream side end portion of the second medium by using the second nozzle.

According to the liquid ejecting apparatus, it is possible to further reduce a printing time.

A liquid ejecting method includes: transporting a first medium and a second medium successively in a transport direction; supporting a transport-direction upstream side end portion of the first medium by using a first supporting member, and supporting a transport-direction downstream side end portion of the second medium by using a second supporting member; moving the first supporting member in the transport direction according to transportation of the first medium, and moving the second supporting member in the transport direction according to transportation of the second medium; and ejecting liquid on each medium positioned in a printable area.

Hereinafter, embodiments of the invention will be described by using a printer having one liquid ejecting apparatus.

### Whole Configuration

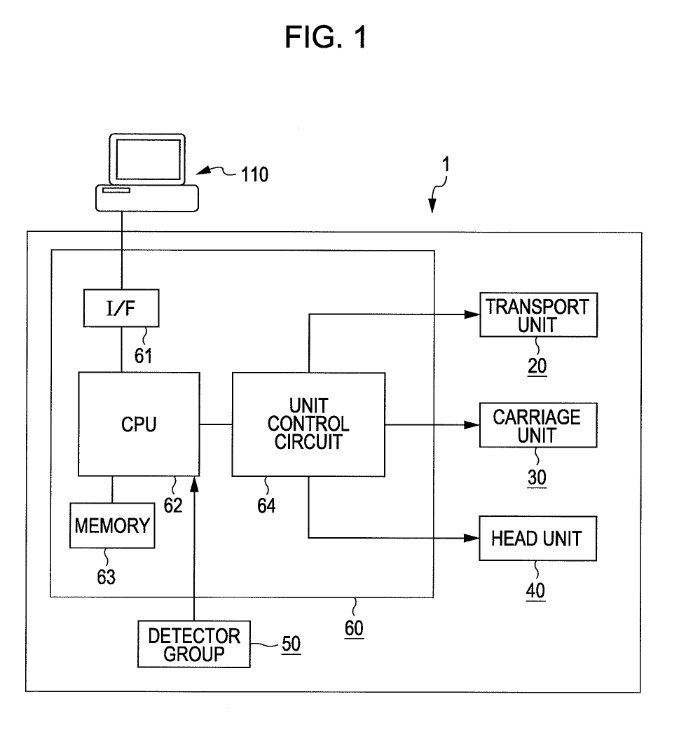

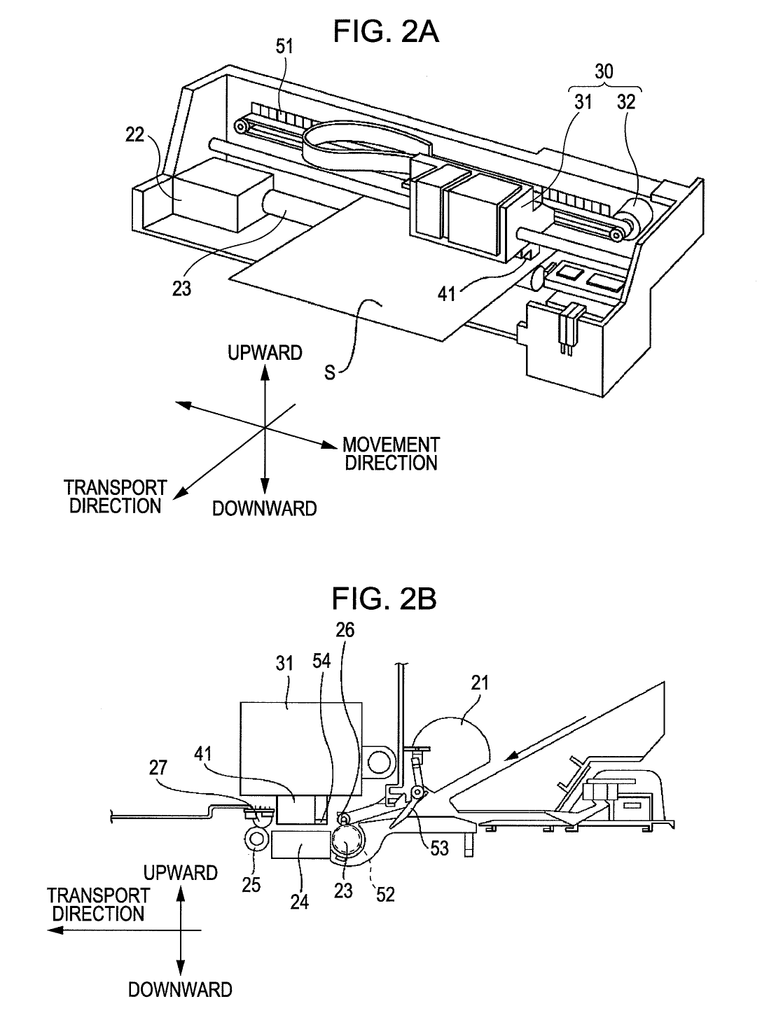

FIG. 1 is a block diagram illustrating the whole configuration of a printer 1. FIG. 2A is a schematic view illustrating the printer 1. FIG. 2B is a transverse cross-sectional view illustrating the printer 1. Now, the configuration of the printer 1 is described with reference to the figures.

The printer 1 includes a transport unit 20, a carriage unit 30, a head unit 40, a detector group 50, and a controller 60. When the printer 1 receives a printing command and a printing data from a computer 110 that is an external apparatus, the printer 1 allows the controller 60 to control each unit (the transport unit 20, the carriage unit 30, and the head unit 40). The printer 1 prints an image on a medium (for example, a sheet S) based on the printing data received from the computer 110. The status of the printer 1 is monitored by the detector group 50. The detector group 50 outputs a result of the detection to the controller 60. The controller 60 controls each unit based on the result of the detection output from the detector group 50.

The transport unit 20 transports the sheet S in a predetermined direction. Hereinafter, the predetermined direction is referred to as a transport direction (or a sub scan direction). The transport unit 20 includes a feeding roller 21, a transporting motor 22 (referred to as a PF motor), a transporting roller 23, a platen 24, and a discharging roller 25. The feeding roller 21 is a roller for feeding the sheet S, inserted into the sheet inserting opening, into the printer. The transporting roller 23 (corresponding to a first roller) is a roller for transporting the sheet S fed by the feeding roller 21 to a printable area. The transporting roller 23 is driven by the transporting motor 22. The platen 24 supports the sheet S during the printing. The platen 24 is disposed under a head 41 which will be described later. In addition, a lengthwise direction length of the platen 24 is designed to be longer than a width of the transportable sheet S. The discharging roller 25 (corresponding to a second roller) is a roller for discharging the sheet S outside the printer. The discharging roller 25 is disposed at a transport-direction downstream side with respect to the printable area. The discharging roller 25 is rotated in synchronization with the transporting roller 23. In addition, rotations of the feeding roller 21, the transporting roller 23, and the discharging roller 25 are controlled by the controller 60.

When the sheet S is transported by the transporting roller 23, the sheet S is interposed between the transporting roller 23 and the driven roller 26. Therefore, the posture of the sheet S can be stabilized. In addition, when the sheet S is transported by the discharging roller 25, the sheet S is interposed between the discharging roller 25 and the driven roller 27. Therefore, the posture of the sheet S can be stabilized.

The carriage unit 30 is used to move the head in a direction intersecting the transport direction. Hereinafter, the direction intersecting the transport direction is set to a movement direction (referred to as a main scan direction). The carriage unit 30 includes a carriage 31 and a carriage motor 32 (referred to as a CR motor). The carriage 31 driven by the carriage motor 32 can perform reciprocating movement in the movement direction. In addition, the carriage 31 detachably holds an ink cartridge that contains ink.

The head unit 40 has a head 41 that ejects the ink on the sheet S. In addition, a plurality of nozzles that eject the ink is disposed on a lower surface of the head 41. The relationship between the head 41 and the nozzles will be described later.

The detector group 50 includes a linear encoder 51, a rotary encoder 52, a sheet detecting sensor 53, and an optical sensor 54. The linear encoder 51 detects a movement direction position of the carriage 31. The rotary encoder 52 detects a rotation amount of the transporting roller 23. The sheet detecting sensor 53 detects a front end (transport-direction downstream side end portion) and a rear end (transport-direction upstream side end portion) of the sheet S during the feeding thereof. The optical sensor 54 detects existence of the sheet S by using a light-emitting portion and a light-receiving portion which are disposed to the carriage 31. In addition, the optical sensor 54 is moved by the carriage 31 to detect positions of the end portions of the sheet S and a width of the sheet S. In addition, the optical sensor 54 can detect the front end and the rear end of the sheet S according to the status.

The controller 60 is a control unit for controlling the printer 1. The controller 60 includes an interface unit 61, a CPU 62, a memory 63, and a unit control circuit 64. The interface unit 61 performs data communication between the computer 110 (an external apparatus) and the printer 1. The CPU 62 is an arithmetic processing unit for controlling the entire portion of the printer. The memory 63 is used for securing an area for storing or executing programs of the CPU 62. The memory 63 includes storage devices such as an RAM and an EEPROM. The CPU 62 allows the unit control circuit 64 to control each of the units according to the programs stored in the memory 63.

### Configuration of Head Unit

The head unit 40 according to the embodiment includes the head 41.

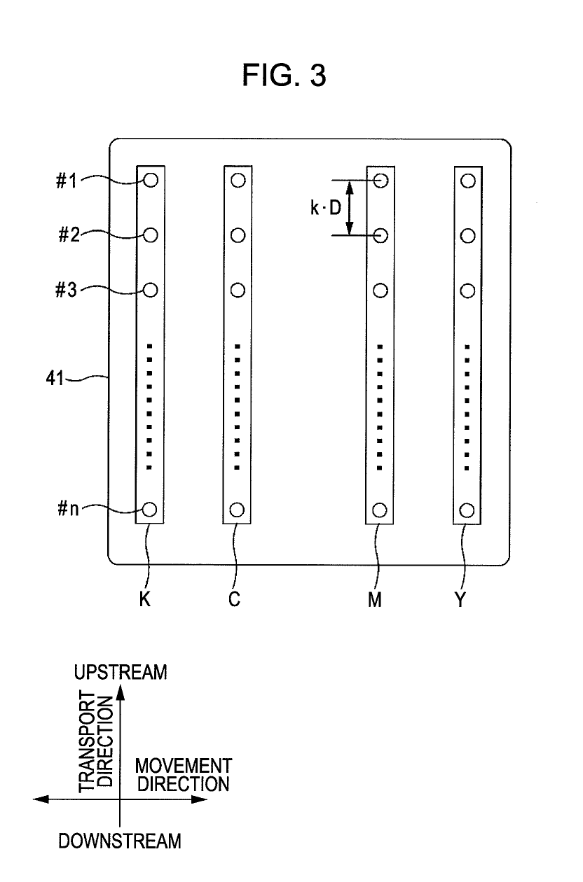

FIG. 3 is a view for explaining the head 41. In the figure, the head unit 40 is shown as viewed in perspective from an upper portion of the printer 1.

The head 41 includes a plurality of nozzle columns where a plurality (n) of nozzles is aligned in the transport direction. In the case shown in FIG. 3, the head 41 includes four nozzle columns (a yellow (Y) ink nozzle column, a magenta (M) ink nozzle column, a cyan (C) ink nozzle column, and a black (K) ink nozzle column). In addition, the nozzles of each nozzle column are denoted by reference numerals (#1, #2, #3, . . . , # n) in the ascending order from the transport-direction downstream side.

The nozzles of each nozzle column are aligned at a nozzle pitch D in the transport direction. Since the head 41 is disposed to the carriage 31, when the carriage 31 is moved in the movement direction, the head 41 is also moved in the same direction (movement direction). In addition, by intermittently ejecting the ink on the head 41 during the movement thereof, dot columns are formed along the movement direction on the sheet S.

### Printing Procedure

When receiving printing commands and printing data from the computer 110, the controller 60 analyzes details of various kinds of commands included in the printing data and performs the following processes by using each unit.

Firstly, the controller 60 rotates the feeding roller 21 to transport a to-be-printed sheet S to the transporting roller 23. Next, the controller 60 drives the transporting motor 22 to rotate the transporting roller 23. When the transporting roller 23 is rotated by a predetermined rotation amount, the sheet S is transported by a predetermined transportation amount.

When the sheet S is transported to a lower portion of the head unit 40, the controller 60 rotates the carriage motor 32 based on the printing commands. By the rotation of the carriage motor 32, the carriage 31 is moved in the movement direction. In addition, by the movement of the carriage 31, the head unit 40 provided to the carriage 31 is simultaneously moved in the movement direction. During the time when the head unit 40 is moved in the movement direction, the controller 60 intermittently ejects ink droplets by using the head 41. Due to the landing of the ink droplets on the sheet S, the dot columns where a plurality of the dots is aligned in the movement direction are formed.

During the time when the head unit 40 performs the reciprocating movement, the controller 60 drives the transporting motor 22. The transporting motor 22 generates a rotation-direction driving force according to a driving amount designated by the controller 60. In addition, the transporting motor 22 rotates transporting roller 23 by using the driving force. When the transporting roller 23 is rotated by a predetermined rotation amount, the sheet S is transported by a predetermined transportation amount. In other words, the transportation amount of the sheet S is defined according to the rotation amount of the transporting roller 23. In this manner, the reciprocating movement of the head unit 40 and the transportation of the sheet S are alternately repeated, so that dots are formed at pixels of the sheet S. Accordingly, an image is printed on the sheet S.

### First Embodiment

### COMPARATIVE EXAMPLE

Before the embodiment of the invention is described, a comparative example is described.

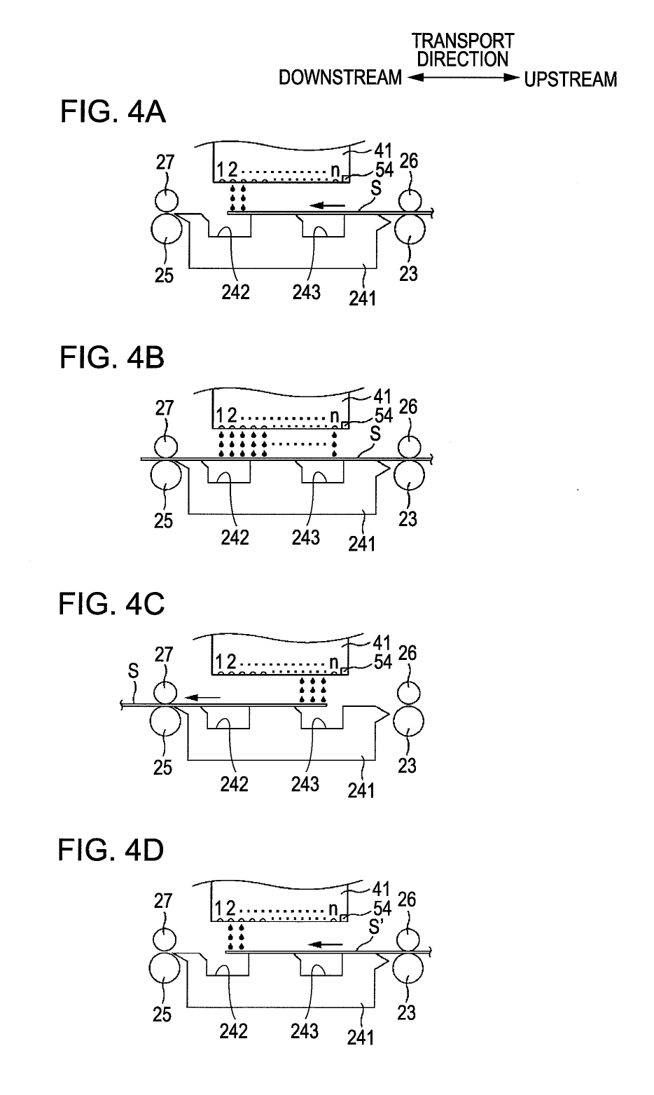

FIGS. 4A to 4D are views for explaining a printing method according to the comparative example. In the comparative example, a printing method (so-called a board-less printing method) of forming no margin on a sheet S is shown.

As shown in the figure, in the comparative example, the platen 241 that supports the sheet S is disposed under the head 41. A downstream side groove 242 is formed at a transport-direction downstream side on an upper surface (a surface supporting the sheet S) of the platen 241, and an upstream side groove 243 is formed at a transport-direction upstream side. The downstream side groove 242 and the upstream side groove 243 are used as an ink receptacle for receiving the ink that deviates from the sheet S.

Firstly, by the rotation of the transporting roller 23 (and the driven roller 26), the sheet S is transported in the transport direction. At this time, the optical sensor 54 detects the front end of the sheet S. From the time when the optical sensor 54 detects the front end of the sheet S, the controller 60 rotates the transporting roller 23 by a predetermined rotation amount. Therefore, as shown in FIG. 4A, the sheet S is transported to the position where the front end thereof is positioned at the downstream side groove 242 of the platen 241. Under the state, the reciprocating movement of the head unit 40 and the transportation of the sheet S are alternately repeated, so that dots are formed at pixels of the sheet S.

FIG. 4A, the dots are formed on the front end portion of the sheet S by using the transport-direction downstream side nozzles (denoted by lower reference numerals) of the head 41 (hereinafter, referred to as a front end treatment). At this time, since the ink that deviates from the sheet S (that is, the ink that does not land on the sheet S) lands in the downstream side groove 242, the upper surface of the platen 241 is not contaminated. In the front end treatment, available nozzles (that is, the transport-direction downstream side nozzles of the head 41) are limited, and other nozzles are not used.

The reciprocating movement of the head unit 40 and the transportation of the sheet S are alternately repeated. When the printing for the front end portion of the sheet S is ended, as shown in FIG. 4B, dots are formed on a central portion of the sheet S (hereinafter, referred to as a normal process). At this time, all the nozzles of the head 41 can be used. The transport-direction downstream side (front end side) portion of the sheet S where the dots are formed are discharged outside the printer 1 by the discharging roller 25 that is rotated in synchronization with the transporting roller 23.

In addition, the reciprocating movement of the head unit 40 and the transportation of the sheet S are alternately repeated, so that the rear end of the sheet S is detected by the optical sensor 54, as shown in FIG. 4C. In this case, the controller 60 rotates the discharging roller 25 by a predetermined rotation amount, so that the rear end of the sheet S is positioned at the upstream side groove 243 of the platen 41. Under the state, the dots are formed on the rear end of the sheet S by using the transport-direction upstream side nozzles (denoted by higher reference numerals) of the head 41 (hereinafter, referred to as a rear end treatment). At this time, since the ink that deviates from the sheet S lands in the upstream side groove 243, the upper surface of the platen 241 is not contaminated. In the rear end treatment, available nozzles (that is, the transport-direction upstream side nozzles of the head 41) are limited, and other nozzles are not used.

When the printing for the sheet S is ended, the sheet S is discharged outside the printer 1. Next, as shown in FIG. 4D, the next sheet (referred to as a sheet S′) is transported to the printable area. In this case, as described above, the sheet S′ is transported until the front end of the sheet S′ is positioned at the downstream side groove 242 of the platen 241. Next, the same printing as that of the sheet S is performed on the sheet S′.

### Configuration of Platen of First Embodiment

Next, a first embodiment is described.

Firstly, a configuration of a platen 24 according to the first embodiment is described.

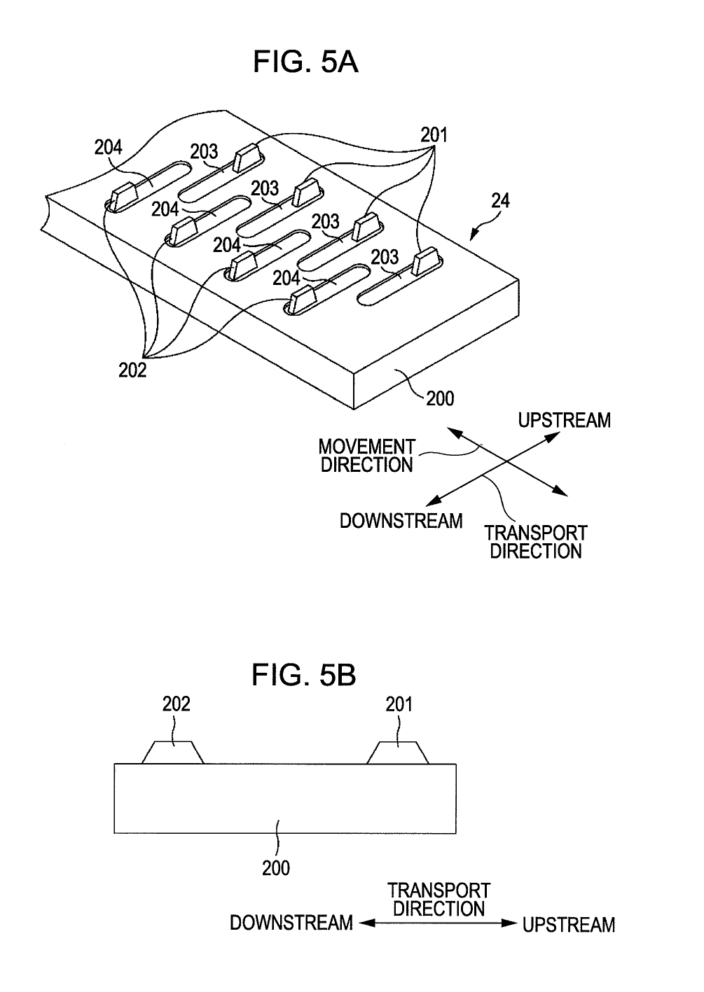

FIG. 5A is a perspective view illustrating the platen 24 according to the first embodiment, and FIG. 5B is a side view illustrating the platen 24 according to the first embodiment.

The platen 24 according to the first embodiment includes a frame 200, a plurality of first ribs 201, and a plurality of second ribs 202.

The frame 200 is made of, for example, a resin or a steel plate. The frame 200 constitutes a body of the platen 24. In addition, in the frame 200, a plurality of openings 203 and a plurality of openings 204 are provided. Each opening 203 is formed by opening a portion ranging from the transport-direction upstream side to a substantially-central portion on the upper surface of the frame 200 in an “I” shape. Each opening 204 is formed by opening a portion ranging from the transport-direction substantially-central portion to the downstream side on the upper surface of the frame 200 in an “I” shape. The openings 203 and the openings 204 are alternately formed in the lengthwise direction (movement direction) of the frame 200.

Each of the first ribs 201 is an thin plate member that supports the sheet S. Each of the first ribs is formed to protrude from the corresponding opening 203. In addition, each of the first ribs 201 can be moved within the corresponding opening 203 in the transport direction. Accordingly, each of the first ribs 201 can be moved in a range from the transport-direction upstream side to the substantially-central portion of the frame 200.

Each of the second ribs 202 is an thin plate member that supports the sheet S. Each of the first ribs is formed to protrude from the corresponding opening 204. In addition, each of the second ribs 202 can be moved within the corresponding opening 204 in the transport direction. Accordingly, each of the second ribs 202 can be moved in a range from the transport-direction downstream side to the substantially-central portion of the frame 200.

In addition, the first ribs 201 and the second ribs 202 can independently move in the transport direction. In addition, when the first rib 201 moves to the furthest end portion of the transport-direction downstream side (the downstream side end of the opening 203) and the second rib 202 moves to the furthest end portion of the transport-direction upstream side (the upstream side end of the opening 204), the first rib 201 and the second rib 202 are positioned at the same position in the transport direction.

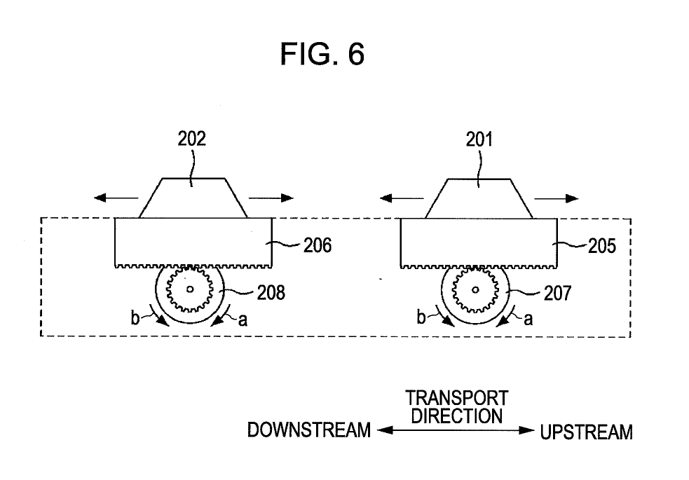

FIG. 6 is a view for explaining an example of a driving method for the first rib 201 and the second rib 202.

In FIG. 6, as a driving mechanism for driving the first rib 201 and the second rib 202, a base 205, a base 206, a moving motor 207, and a moving motor 208 are shown.

In the base 205, a straight-line-shaped gear is formed on a lower surface thereof, and the first rib 201 is disposed on the upper surface thereof.

The moving motor 207 has teeth engaged with the gear of the lower surface of the base 205, so that the a-direction rotation and the b-direction rotation thereof is controlled by the controller 60. According to this configuration, if the controller 60 rotates the moving motor 207 in the “a” direction, the first rib 201 is moved to the transport-direction upstream side. In addition, if the controller 60 rotates the moving motor 207 in the “b” direction, the first rib 201 is moved to the transport-direction downstream side.

In the base 206, a straight-line-shaped gear is formed on a lower surface thereof, and the second rib 202 is disposed on the upper surface thereof.

The moving motor 208 has teeth engaged with the gear of the lower surface of the base 206, so that the a-direction rotation and the b-direction rotation thereof is controlled by the controller 60. According to this configuration, if the controller 60 rotates the moving motor 208 in the “a” direction, the second rib 202 is moved to the transport-direction upstream side. In addition, if the controller 60 rotates the moving motor 208 in the “b” direction, the second rib 202 is moved to the transport-direction downstream side.

In this manner, since the controller 60 controls the rotation of the moving motor 207 and the rotation of the moving motor 208, the first rib 201 and the second rib 202 can be independently moved in the transport direction. In addition, since a plurality of the first ribs 201 is provided on the upper surface of the base 205, the first ribs 201 are also moved according to the movement of the base 205. In addition, since a plurality of the second ribs 202 is provided on the upper surface of the base 206, the second ribs 202 are also moved according to the movement of the base 206. As described above, the movement ranges of the first rib 201 and the second rib 202 are different from each other.

### Printing Method of First Embodiment

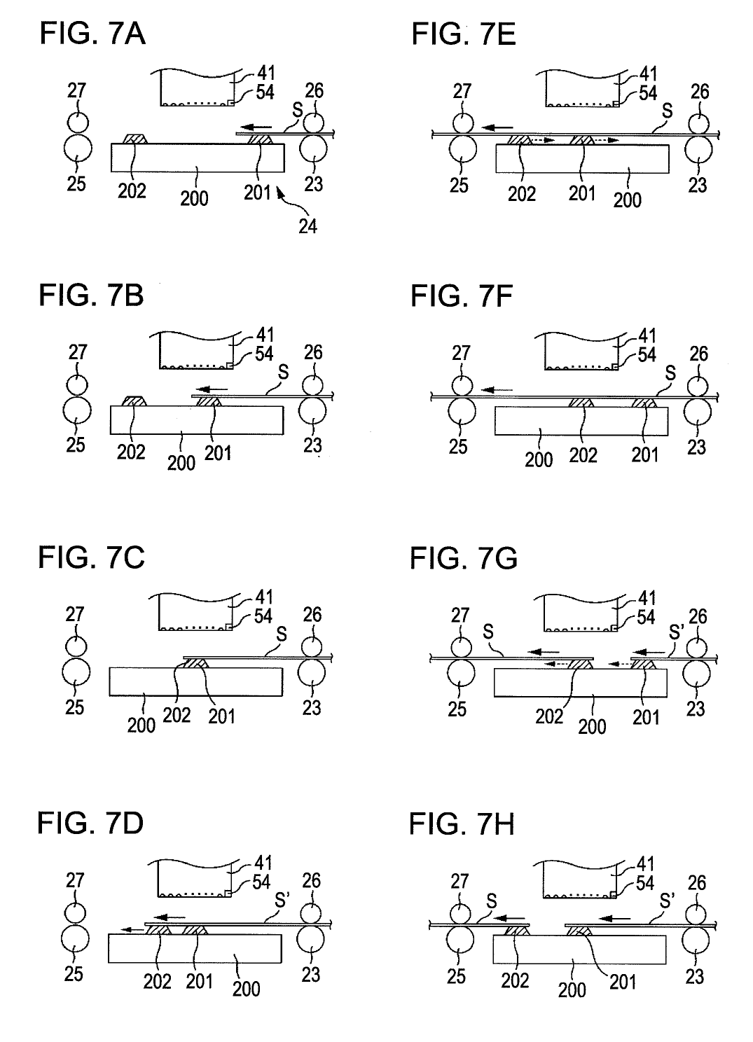

FIGS. 7A to 7H are views for explaining a printing method according to the first embodiment.

In the following embodiment, the printing is performed in a board-less printing mode. In the board-less printing, the ink is ejected on an area beyond the front end (transport-direction downstream side end portion) and the rear end (transport-direction upstream side end portion) of the medium, so that no margin is formed in the end portion of the medium. At this time, the ink is attached on the frame 200 of the platen 24. The frame 200 serves as an ink receptacle. Since the medium is supported by the ribs, the medium is not in contact with the frame 200 of the platen 24, the medium is not contaminated. In the board-less printing, since the printing data is created to be larger than that for the medium, the printing is performed over the end portion of the medium with a predetermined exceeding amount of the ink.

At the time of starting the printing, the first rib 201 is positioned at the transport-direction upstream side with respect to the head 41, and the second rib 202 is positioned at the transport-direction downstream side with respect to the head 41.

Firstly, the sheet S fed by the feeding roller 21 is transported in the transport direction by the transporting roller 23. At this time, the optical sensor 54 detects the front end of the sheet S. From the time when the optical sensor 54 detects the front end of the sheet S, the controller 60 rotates the transporting roller 23 by a predetermined rotation amount. Therefore, as shown in FIG. 7A, the sheet S is transported to the position (that is, an initial position) where the front end thereof slightly passes the first rib 201. Under the state, the dot forming operation by the reciprocating movement of the head unit 40 and the transporting operation of transporting the sheet S in the transport direction are alternately repeated, so that an image is printed on the sheet S. Hereinafter, the dot forming operation through the movement direction movement of the head unit 40 is referred to as a “pass”. Firstly, the front end of the sheet S is transported to the position facing the transport-direction upstream side nozzle of the head 41.

In the first pass, the controller 60 forms the dots on the front end portion of the sheet S by using the nozzles (transport-direction upstream side nozzles) of the head 41 facing the sheet S at the initial position. At this time, the second rib 202 that is positioned at the transport-direction downstream side with respect to the head 41 is not contaminated. After the first pass, the controller 60 rotates the transporting roller 23 to transport the sheet S in the transport direction (transporting operation). When the transporting operation is performed, the controller 60 moves the first rib 201 that supports the front end of the sheet S in the transport direction in accordance with the transportation of the sheet S. In other words, the first rib 201 supports the front end of the sheet S and is moved in the transport direction. On the other hand, the second rib 202 is positioned at the transport-direction downstream side without movement thereof.

In the second pass, the controller 60 forms the dots on the sheet S by using the nozzles of the head 41 facing the sheet S. In the second pass, the number of nozzles facing the sheet S according to the transportation amount of the sheet S in the transporting operation is larger than that of the first pass. That is, in the second pass, the number of nozzles that is larger than that of the first pass can be used. After the second pass, the controller 60 also rotates the transporting roller 23 to transport the sheet S in the transport direction (transporting operation). In addition, at the time of the transporting operation, the first rib 201 is moved in accordance with the transportation of the sheet S in the transport direction.

Next, the pass and the transporting operation (and the movement of the first rib 201) are alternately repeated. Every time when the transporting operation is performed, the sheet S and the first rib 201 are moved in the transport direction. Every time when the pass proceeds, the number of available nozzles (nozzles corresponding to the sheet S) is increased in the transport direction. The second rib 202 is positioned at the transport-direction downstream side.

Next, as shown in FIG. 7B, the first rib 201 reaches the transport-direction substantially-central portion (the transport-direction downstream side end of the opening 203) of the frame 200. Therefore, the controller 60 cannot move the first rib 201 in the transport direction.

In the next transporting operation (at the time when the ink is not ejected), as shown in FIG. 7C, the controller 60 moves the second rib 202 toward the transport-direction upstream side. Therefore, the second rib 202 positioned at the transport-direction downstream side is moved to the transport-direction substantially-central portion (the same position as that of the first rib 201), so that the front end of the sheet S is supported. Accordingly, the second rib 202 can be moved to the transport-direction upstream side without contamination with the ink.

Next, the pass and the transporting operation of the sheet S are alternately repeated. In addition, in the transporting operation, the controller 60 moves the second rib 202 in the transport direction in accordance with the transportation of the sheet S in the transport direction. In other words, as shown in FIG. 7D, the second rib 202 supports the front end of the sheet S and is moved in the transport direction. On the other hand, the first rib 201 is positioned at the transport-direction substantially-central portion and supports the sheet S. Every time when the pass proceeds, the number of available nozzles (nozzles facing the sheet S) is increased in the transport direction. Next, when all the nozzles of the head 41 face the sheet S, all the nozzles of the head 41 can be used for the pass. That is, the number of available nozzles is maximized.

Next, the second rib 202 reaches the transport-direction downstream side (transport-direction downstream side end of the opening 204) of the frame 200. In the next transporting operation, the controller 60 transports only the sheet S in the transport direction by using the transporting roller 23.

In addition, as shown in FIG. 7E, if the pass and the transporting operation are alternately repeated, the sheet S is transported by the transporting roller 23 and the discharging roller 25 (hereinafter, referred to as an intermediate printing). At this time, the sheet S at the transport-direction upstream side is interposed between the transporting roller 23 and the driven roller 26. In addition, the sheet S at the transport-direction downstream side is interposed between the discharging roller 25 and the driven roller 27. Therefore, the posture of the sheet S between the transporting roller 23 and the discharging roller 25 is stabilized.

In the state, the controller 60 moves the first rib 201 and the second rib 202 toward the transport-direction upstream side. Accordingly, the first rib 201 and the second rib 202 can be moved to the transport-direction upstream side without losing postures of the sheet S. As shown in FIG. 7F, by the movement, the first rib 201 is moved from the substantially-central portion to the transport-direction upstream side of the frame 200, and the second rib 202 is moved from the transport-direction downstream side to the substantially-central portion of the frame 200. In the next transporting operation, the controller 60 transports only the sheet S in the transport direction by using the transporting roller 23 and the discharging roller 25 without movement of the first rib 201 and the second rib 202.

Next, if the rear end of the sheet S is detected by the sheet detecting sensor 53 (refer to FIG. 2B) in any one of transporting operations, the controller 60 immediately rotates the feeding roller 21 and starts to transport the next sheet (refer to as a sheet S′). At this time, an interval between the rear end of the preceding transported sheet S (corresponding to the first medium) and the front end of the following transported sheet S′ (corresponding to the second medium) is set to be smaller than the interval between the first rib 201 and the second rib 202 shown in FIG. 7F. In addition, the preceding transported sheet S is transported only by the discharging roller 25, and the following transported sheet S′ is transported only by the transporting roller 23. Therefore, the sheet S and the sheet S′ can be transported in the state where the sheets reach each other as close as possible.

In addition, if the rear end of the sheet S (or the front end of the sheet S′) is detected by the optical sensor 54, the controller 60 rotates the transporting roller 23 and the discharging roller 25 by predetermined rotation amounts in the next transporting operation. Therefore, the sheet S is transported by the discharging roller 25 at the position where the rear end thereof reaches slightly before the second rib 202, and the sheet S′ is transported by the transporting roller 23 at the position where the front end thereof slightly passes the first rib 201 (that is, the initial position of the sheet S′).

In this manner, when the printing is performed on the rear end of the sheet S, the controller 60 positions the front end of the next sheet S′ under the head 41. Next, under the state, the pass for forming dots on the sheet S and the sheet S′ and the transporting operation for transporting the sheet S and the sheet S′ in the transport direction are repeatedly performed.

In the pass, the dots are formed on the rear end of the sheet S by the nozzles (corresponding to the first nozzles) of the head 41 facing the sheet S, and at the same time, the dots are formed on the front end of the sheet S′ by the nozzles (corresponding to the second nozzles) of the head 41 facing the sheet S′. In addition, since the interval between the rear end of the sheet S and the front end of the sheet S′ is set to be smaller than the interval between the first rib 201 and the second rib 202, the ink cannot land on the first rib 201 and the second rib 202. Therefore, at the time of the pass, the first rib 201 and the second rib 202 cannot be contaminated with the ink.

In the transporting operation, as shown in FIG. 7G, the controller 60 moves the second rib 202 in the transport direction in accordance with the transportation of the sheet S in the transport direction. The controller 60 moves the first rib 201 in the transport direction in accordance with the transportation of the sheet S′ in the transport direction. In other words, the second rib 202 supports the rear end of the preceding transported sheet S and is moved in the transport direction, and the first rib 201 supports the front end of the following transported sheet S′ and is moved in the transport direction. Every time when the transporting operation is performed, since the sheet S and the sheet S′ are transported in the transport direction, the number of nozzles facing the sheet S is decreased. On the contrary, the number of nozzles facing the sheet S′ is increased. Therefore, every time when the pass proceeds, the number of nozzles for forming dots on the sheet S is decreased, and the number of nozzles for forming dots on the sheet S′ is increased. Therefore, in terms of the entire head 41, the substantially constant number of nozzles can be used for each pass.

Next, as shown in FIG. 7H, the first rib 201 reaches the transport-direction substantially-central portion (transport-direction downstream side end of the opening 203) of the frame 200, and the second rib 202 reaches the transport-direction downstream side (transport-direction downstream side end of the opening 204) of the frame 200. In the next transporting operation, similarly to the case shown in FIG. 7C, the controller 60 moves the second rib 202 toward the transport-direction upstream side. The second rib 202 is moved from the transport-direction downstream side to the substantially-central portion and supports the front end of the sheet S′ without contamination with the ink. In the next transporting operation, the controller 60 moves the second rib 202 in the transport direction in accordance with the transportation of the sheet S′ in the transport direction. The sheet S is transported (discharged) outside the printer 1 by the discharging roller 25.

Next, the same printing as that of the sheet S is performed on the sheet S′.

### COMPARATIVE EXAMPLE

In a comparative example, in order not to contaminate the upper surface of the platen 241 with ink, the printing for the front end of the sheet S is performed on the downstream side groove 242 of the platen 241, and the printing for the rear end of the sheet S is performed on the upstream side groove 243 of the platen 241. Therefore, the next sheet S′ is transported in the printable area after the printing for the sheet S is ended. In other words, the sheet S and the sheet S′ cannot be successively transported to the printable area.

However, according to the embodiment, the platen 241 includes the first rib 201 and the second rib 202 that can be independently moved in the transport direction. In addition, the second rib 202 supporting the rear end of the preceding transported sheet S can be moved in the transport direction, and at the same time, the first rib 201 supporting the front end of the following transported sheet S′ can be moved in the transport direction. Accordingly, the printing time can be reduced.

When the printing is performed in the vicinity of the rear end of the sheet S, the second rib 202 supporting the rear end of the sheet S is moved from the position facing the nozzles of the head 41 to the transport-direction downstream side (the position not facing the nozzles of the head 41) with respect to the head 41. Therefore, although the printing is performed on the rear end of the sheet S by using any nozzles of the head 41, no ink lands on the second rib 202. Similarly, in the figure, when the printing is performed in the vicinity of the front end of the sheet S′, the first rib 201 supporting the front end of the sheet S′ is moved from the transport-direction upstream side (the position not facing the nozzles of the head 41) with respect to the head 41 to the position facing the nozzles of the head 41. Therefore, although the printing is performed by using any nozzles of the head 41, no ink lands on the first rib 201.

In addition, in the comparative example, when the printing is performed on the front end or rear end of the sheet S, the number of available nozzles among the nozzles of the head 41 is small, but the number of unavailable nozzles is large. For example, in the front end treatment for the sheet S, only the nozzles of the transport-direction downstream side among the nozzles of the head 41 are used. In the rear end treatment, only the nozzles of the transport-direction upstream side among the nozzles of the head 41 are used. Therefore, printing efficiency deteriorates, so that the printing time is increased.

However, in the embodiment, when the printing is performed on the rear end of the preceding transported sheet S, the controller 60 positions the front end of the following transported sheet S′ under the head 41. n a case where the dots are formed on the rear end of the sheet S by the nozzles (transport-direction downstream side nozzles) of the head 41 facing the sheet S, the dots are formed on the front end of the sheet S′ by the nozzles (transport-direction upstream side nozzles) of the head 41 facing the sheet S′. In other words, the printing on the rear end of the sheet S and the printing on the front end of the sheet S′ are performed simultaneously. Therefore, the number of unavailable nozzles among the nozzles of the head 41 can be reduced, so that the dots can be efficiently formed on the sheet S and the sheet S′. Accordingly, the printing time can be reduced.

In the embodiment, when the first rib 201 reaches substantially-central portion of the frame 200, the second rib 202 is moved to the substantially-central portion of the frame 200 and supports the front end of the sheet S. However, the second rib 202 may be stopped at the transport-direction downstream side. In addition, at the time of the next intermediate printing, the first rib 201 and the second rib 202 may be moved toward the transport-direction upstream side.

In the addition, the invention is not limited to the embodiment, but the second rib 202 is positioned at the transport-direction downstream side with respect to the nozzles of the head 41 and supports the preceding medium (sheet S). Just after the printing for the sheet S is ended and the sheet S is discharged, the first rib 201 may support the next medium (sheet S′), so that the medium can be fed. In this case, during the time when the printing is performed on the preceding sheet S, the next sheet S′ is on standby in the state that the sheet S′ is supported by the first rib 201 at the transport-direction upstream side with respect to the nozzles of the head 41. Just after the printing for the sheet S is ended, the next sheet S′ is preferably transported to the printable area. In addition, it is preferable that the next sheet S′ is on standby in the state where the front end thereof is detected by the sensor 54. In the embodiment, since two supporting members (ribs) for supporting the medium are provided, just after the one rib supporting the sheet S is moved out from the printable area to the transport-direction downstream side, the other rib supporting the next sheet S′ is moved into the printable area. Therefore, the printing the next sheet S′ can be started in a short time.

In addition, the sensor 54 may be provided at the position where the front end and the rear end of the medium can be detected at the transport-direction upstream side with respect to the printable area. For example, the sensor 54 may be provided to the carriage 31 at the transport-direction upstream side with respect to the printable area. Alternatively, the sensor 54 may be provided at the position other than the carriage 31 at the transport-direction upstream side with respect to the carriage 31.

These modified examples can be similarly adapted to the later-described embodiments.

In addition, in the embodiment, the first rib 201 and the second rib 202 are moved in the transport direction based on the rotation of the moving motor 207 and the moving motor 208. However, the invention is not limited thereto. The first rib 201 and the second rib 202 may be independently transported in the transport direction.

### Second Embodiment

In a second embodiment, movement ranges of two ribs are different from those of first embodiment.

### Configuration of Platen of Second Embodiment

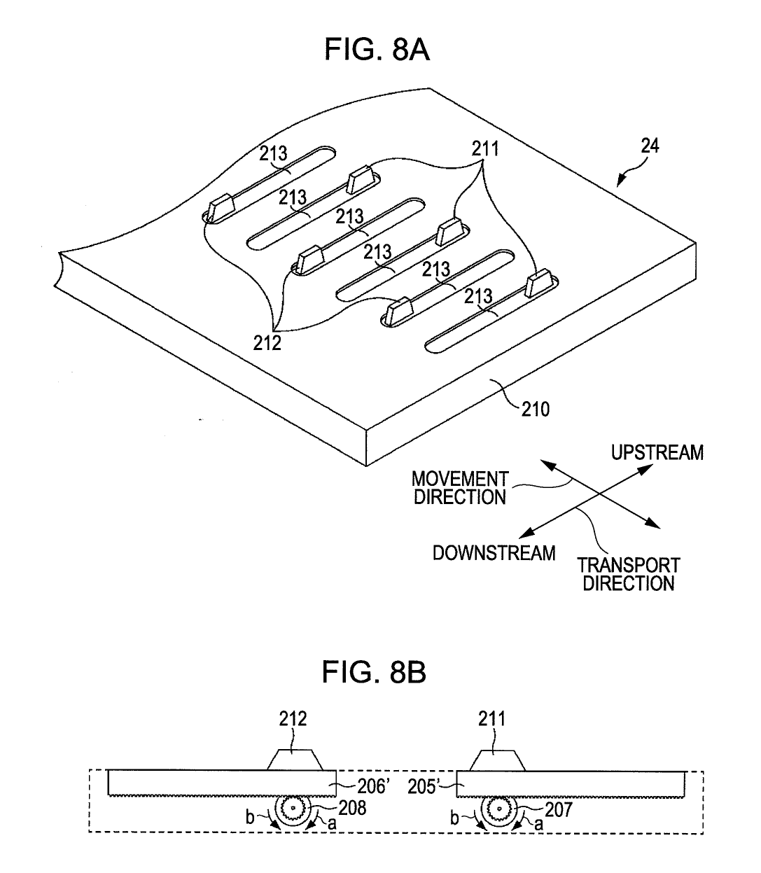

FIG. 8A is a perspective view illustrating a platen 24 according to the second embodiment.

A platen 24 according to the second embodiment includes a frame 210, a plurality of first ribs 211, and a plurality of second ribs 212.

The frame 210 is made of, for example, a resin or a steel plate. The frame constitutes a body of the platen 24. In addition, in the frame 210, openings 213 are provided. Each opening 213 is formed by opening a portion ranging from the transport-direction upstream side to the transport-direction downstream side on the upper surface of the frame 210 in an “I” shape. A plurality of the openings 213 is formed at a predetermined interval in the lengthwise direction (movement direction) on the upper surface of the frame 210.

Each first rib 211 and each second rib 212 are thin plate members that support the sheet S. Each first rib 211 and each second rib 212 are formed to alternately protrude from the corresponding openings 213 that are aligned in the movement direction. In addition, each first rib 211 and each second rib 212 can be moved within the corresponding openings 213 in the transport direction. Accordingly, each first rib 211 and each second rib 212 can be moved in a range from the transport-direction upstream side to the transport-direction downstream side of the openings 213. In addition, similarly to the first embodiment, the first ribs 211 and the second ribs 212 can be independently moved in the transport direction.

FIG. 8B is a view for explaining an example of a driving method for the first rib 211 and the second rib 212. In addition, in FIG. 8B, the same elements as those of FIG. 6 are denoted by the same reference numerals.

In FIG. 8B, as a driving mechanism for driving the first rib 211 and the second rib 212, a base 205′, a base 206′, a moving motor 207, and a moving motor 208 are shown.

The first rib 211 is disposed on the upper surface of the base 205′, and the second rib 212 is disposed on the upper surface of the base 206′.

The transport-direction lengths of the base 205′ and the base 206′ are larger than those of the base 205 and the base 206 according to the first embodiment. Therefore, movement ranges of the base 205′ and the base 206′ are increased. In addition, although not shown, each of the bases 205′ and each of the bases 206′ have a comb shape in the movement direction in the portion where the ribs are disposed, and the bases 205′ and the bases 206′ in the rib portions are alternately interlaced in the movement direction. Therefore, the first ribs 211 and the second ribs 212 can be alternately aligned along one line in the movement direction.

### Printing Method of Second Embodiment

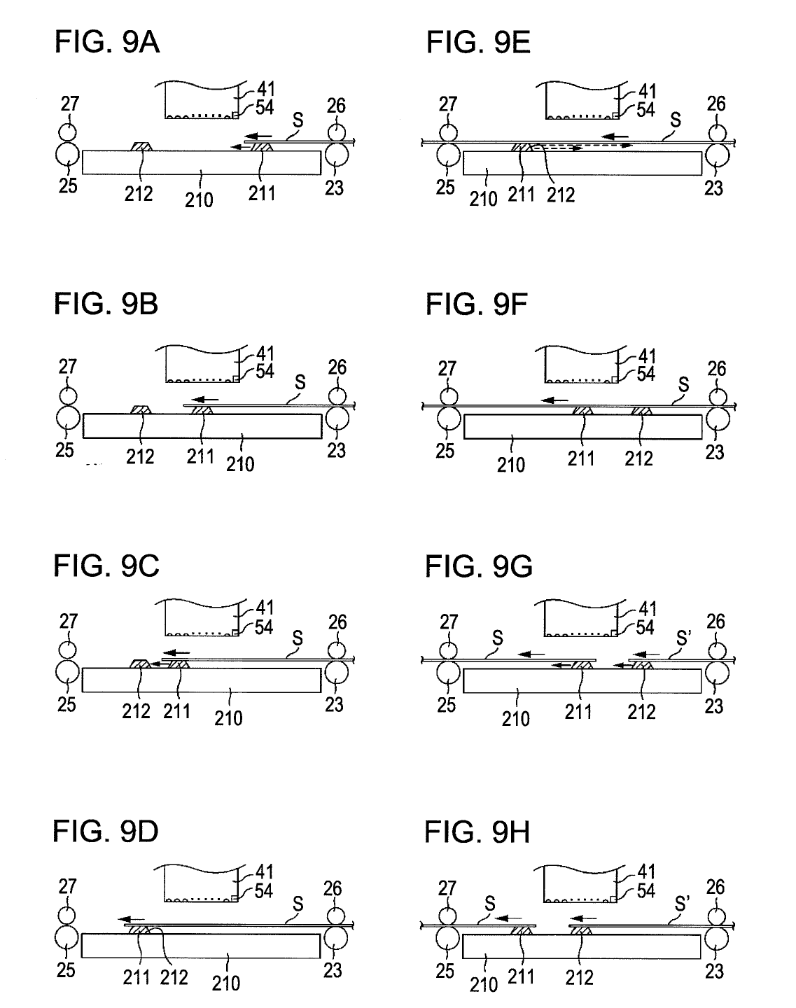

FIGS. 9A to 9H are views for explaining a printing method according to the second embodiment.

At the time of starting the printing, the first rib 211 is positioned at the transport-direction upstream side with respect to the head 41, and the second rib 212 is positioned at the transport-direction downstream side with respect to the head 41.

Firstly, the sheet S fed by the feeding roller 21 is transported in the transport direction by the transporting roller 23. At this time, the optical sensor 54 detects the front end of the sheet S. From the time when the optical sensor 54 detects the front end of the sheet S, the controller 60 rotates the transporting roller 23 by a predetermined rotation amount. Therefore, as shown in FIG. 9A, the sheet S is transported to the position (that is, an initial position) where the front end thereof slightly passes the first rib 211. Under the state, the dot forming operation (pass) by the reciprocating movement of the head unit 40 and the transporting operation of transporting the sheet S in the transport direction are alternately repeated, so that an image is printed on the sheet S. Firstly, the front end of the sheet S is transported to the position facing the transport-direction upstream side nozzle of the head 41.

In the first pass, the controller 60 forms the dots on the front end portion of the sheet S by using the nozzles (transport-direction upstream side nozzles) of the head 41 facing the sheet S. At this time, the second rib 202 that is positioned at the transport-direction downstream side with respect to the head 41 is not contaminated with the ink. After the first pass, the controller 60 rotates the transporting roller 23 to transport the sheet S in the transport direction (transporting operation). When the transporting operation is performed, the controller 60 moves the first rib 211 that supports the front end of the sheet S in the transport direction in accordance with the transportation of the sheet S. In other words, the first rib 211 supports the front end of the sheet S and is moved in the transport direction. On the other hand, the second rib 212 is positioned at the transport-direction downstream side with respect to the head 41 without movement thereof.

In the second pass, the controller 60 forms the dots on the sheet S by using the nozzles of the head 41 facing the sheet S. In the second pass, the number of nozzles facing the sheet S according to the transportation amount of the sheet S in the transporting operation is larger than that of the first pass. That is, in the second pass, the number of nozzles that is larger than that of the first pass can be used. After the second pass, the controller 60 also rotates the transporting roller 23 to transport the sheet S in the transport direction (transporting operation). In addition, at the time of the transporting operation, the first rib 211 is moved in accordance with the transportation of the sheet S in the transport direction.

Next, the pass and the transporting operation (and the movement of the first rib 211) are alternately repeated. Every time when the transporting operation is performed, as shown in FIG. 9B, the sheet S and the first rib 211 are moved in the transport direction. Therefore, every time when the pass proceeds, the number of available nozzles (nozzles facing the sheet S) is increased in the transport direction. In addition, the second rib 212 is positioned at the transport-direction downstream side. In addition, as shown in FIG. 9C, when the front end of the sheet S is positioned at the position facing the transport-direction downstream side nozzle (#1 nozzle) of the head 41, all the nozzles of the head 41 face the sheet S. Therefore, in the pass, all the nozzles of the head 41 can be used. That is, the number of available nozzles is maximized.

Next, as shown in FIG. 9D, the first rib 211 reaches the transport-direction downstream side (transport-direction downstream side end of the opening 213) of the frame 210. In the next transporting operation, the controller 60 transports only the sheet S in the transport direction by using the transporting roller 23. In addition, at this time, the first rib 211 may not be moved to the transport-direction downstream side end of the opening 213. When the first rib 211 reaches the transport-direction downstream side end in the area facing the nozzles, the first rib 211 may be stopped. In the next transporting operation, only the sheet S may be transported in the transport direction. Next, since the intermediate printing is to be performed, the sheet S is necessarily mounted on the first rib 211. Although the first rib 211 is positioned at the position facing the nozzles, the first rib 211 cannot be contaminated with the ejected ink that deviates from the sheet S. In this case, the sheet S in the printable area is supported by the first rib 211, a more constant distance between the sheet S and the nozzles can be maintained.

In addition, as shown in FIG. 9E, if the pass and the transporting operation are alternately repeated, the sheet S is transported by the transporting roller 23 and the discharging roller 25 (intermediate printing). At this time, the sheet S at the transport-direction upstream side is interposed between the transporting roller 23 and the driven roller 26. In addition, the sheet S at the transport-direction downstream side is interposed between the discharging roller 25 and the driven roller 27. Therefore, the posture of the sheet S between the transporting roller 23 and the discharging roller 25 is stabilized. At the time of the intermediate printing, as shown in FIG. 9F, the controller 60 moves the first rib 211 and the second rib 212 toward the transport-direction upstream side. In addition, the controller 60 moves the first rib 211 to the substantially-central portion of the frame 210. The controller 60 moves the second rib 212 to the transport-direction upstream side of the frame 210. In this manner, at the time of the intermediate printing, since the first rib 211 and the second rib 212 can be moved toward the transport-direction upstream side, the posture of the sheet S cannot be lost. In the next transporting operation, the controller 60 transports only the sheet S in the transport direction by using the transporting roller 23 and the discharging roller 25 without movement of the first rib 211 and the second rib 212.

Next, if the rear end of the sheet S is detected by the sheet detecting sensor 53 in any one of the transporting operations, the controller 60 immediately rotates the feeding roller 21 and starts to transport the next sheet S′. At this time, an interval between the rear end of the preceding transported sheet S and the front end of the following transported sheet S′ is set to be smaller than the interval between the first rib 211 and the second rib 212 shown in FIG. 9F. In addition, the preceding transported sheet S is transported only by the discharging roller 25, and the following transported sheet S′ is transported only by the transporting roller 23.

In addition, if the rear end of the sheet S (or the front end of the sheet S′) is detected by the optical sensor 54, the controller 60 rotates the transporting roller 23 and the discharging roller 25 by predetermined rotation amounts in the next transporting operation. Therefore, the sheet S is transported by the discharging roller 25 at the position where the rear end thereof reaches slightly before the first rib 211, and the sheet S′ is transported by the transporting roller 23 at the position where the front end thereof slightly passes the second rib 212 (that is, the initial position of the sheet S′).

In this manner, when the printing is performed on the rear end of the sheet S, the controller 60 positions the front end of the next sheet S′ under the head 41. Next, under the state, the pass for forming dots on the sheet S and the sheet S′ and the transporting operation for transporting the sheet S and sheet S′ in the transport direction are repeatedly performed. In addition, in the pass, the dots are formed on the rear end of the sheet S by the nozzles of the head 41 facing the sheet S, and at the same time, the dots are formed on the front end of the sheet S′ by the nozzles of the head 41 facing the sheet S′. At this time, the sheet S is supported by the first rib 211, and the sheet S′ is supported by the second rib 212. In addition, in the transporting operation, as shown in FIG. 9G, the controller 60 moves the first rib 211 in the transport direction in accordance with the transportation of the sheet S in the transport direction. In addition, the controller 60 move the second rib 212 in the transport direction in accordance with the transportation of the sheet S′ in the transport direction. In other words, the first rib 211 supporting the rear end of the preceding transported sheet S is moved in the transport direction, and the second rib 212 supporting the front end of the following transported sheet S′ is moved in the transport direction. Every time when the transporting operation is performed, since the sheet S and the sheet S′ are transported in the transport direction, the number of nozzles facing the sheet S is decreased. On the contrary, the number of nozzles facing the sheet S′ is increased. Therefore, every time when the pass proceeds, the number of nozzles for forming dots on the sheet S is decreased, and the number of nozzles for forming dots on the sheet S′ is increased. Therefore, in terms of the entire head 41, the substantially constant number of nozzles can be used for each pass.

As the transporting operation proceeds, as shown in FIG. 9H, the sheet S does not face the nozzles of the head 41, but a portion of the sheet S′ facing the nozzles of the head 41 is increased. In the next pass, the dots are formed on the sheet S′. In addition, in the next transporting operation, the sheet S is transported (discharged) outside the printer 1, and the front end of the sheet S′ together with the second rib 212 is moved in the transport direction in the state where the sheet S′ is supported by the second rib 212. In the next transporting operation, when the second rib 212 reaches the transport-direction downstream side (transport-direction downstream side end of the opening 213) of the frame 210, the controller 60 transports only the sheet S′ in a transport direction by using the transporting roller 23. In addition, at the time of the intermediate printing for the sheet S′, the first rib 211 and the second rib 212 are moved to the transport-direction upstream side.

Next, the same operations are repeatedly performed.

In FIG. 9G, when the printing is performed in the vicinity of the rear end of the sheet S, the second rib 212 is positioned at the position not facing the nozzles of the head 41. Therefore, although the printing is performed on the rear end of the sheet S by using any nozzles of the head 41, no ink lands on the second rib 212. In addition, in FIG. 9H, when the printing is performed in the vicinity of the front end of the sheet S′, the first rib 211 supporting the rear end of the sheet S is moved to the position not facing the head 41. Therefore, although the printing is performed by using any nozzles of the head 41, no ink lands on the first rib 211.

Accordingly, in the second embodiment, since the printing can be performed in the state where the sheet S and the sheet S′ reach each other as close as possible, the printing time can be reduced. In addition, similarly to the first embodiment, the printing can be performed on the rear end of the sheet S and the front end of the sheet S′ simultaneously. Therefore, the printing time can be further reduced.

In addition, in the second embodiment, two ribs can be moved from the upstream side to the downstream side with respect to the nozzle columns of the head 41. Therefore, the one rib (for example, first rib 211) supporting the front end of the sheet S can transport the sheet S to the final position (transport-direction downstream side). In addition, in the embodiment, at the time of the intermediate printing, the second rib 212 is moved toward the transport-direction upstream side. Alternatively, during the intermediate printing, the second rib 212 may be moved to the substantially-central portion of the frame 210 to support the sheet S, and the first rib 211 may be moved to the transport-direction upstream side to stand by the transportation of the next sheet S′. Alternatively, the first rib 211 may be stopped at the substantially-central portion of the frame 210 to continue to support the sheet S. During the intermediate printing, the second rib 212 may be moved to the transport-direction upstream side to stand by the transportation of the next sheet S′. Alternatively, in the transporting operation after the first rib 211 is stopped at the substantially-central portion of the frame 210, the second rib 212 may be moved to the substantially-central portion of the frame 210 to support the front end of the sheet S. In the next transporting operation, the second rib 212 supporting the front end of the sheet S may be moved in the transport direction. In addition, at the time of the next intermediate printing, the second rib 212 may be moved to the transport-direction upstream side.

### Third Embodiment

In the above-described embodiment, two (2 types) ribs are independently moved in the transport direction. However, in a third embodiment, a plurality of ribs is moved simultaneously.

### Configuration of Platen of Third Embodiment

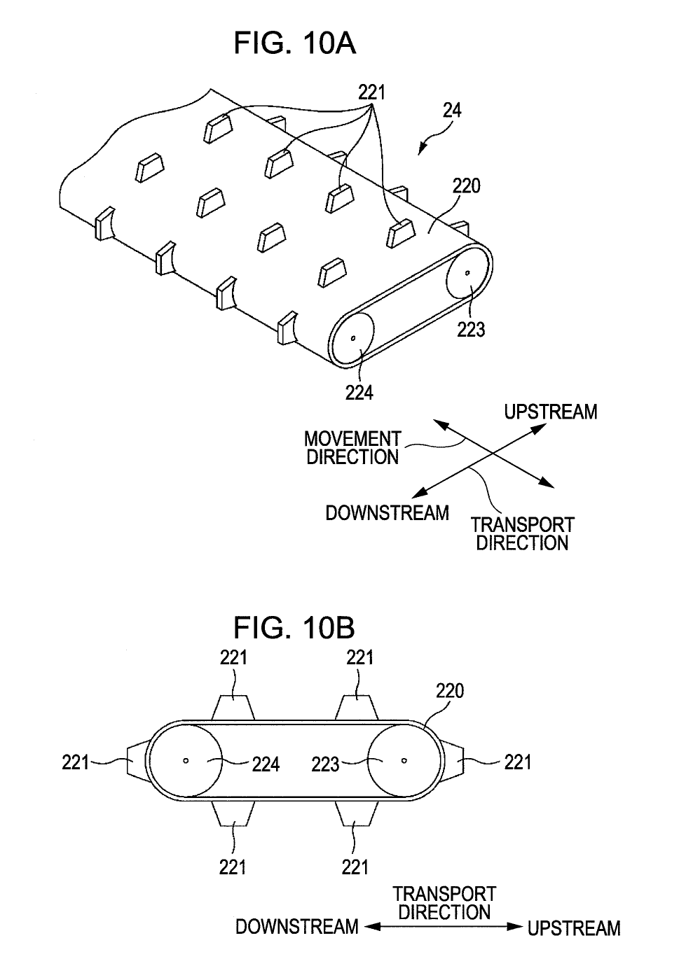

FIG. 10 is a view for explaining an example of a configuration of a platen 24 according to a third embodiment.

The platen 24 according to the third embodiment includes a roller 223, a roller 224, a movement belt 220, and a plurality of ribs 221.

The roller 223 is disposed at the transport-direction upstream side of the platen 24. The roller 224 is disposed at the transport-direction downstream side thereof. The roller 223 and the roller 224 are controlled by the controller 60 to be rotated in a predetermined direction in synchronization with each other.

The movement belt 220 is disposed around the roller 223 and the roller 224 to be rotated according to the rotation of the roller 223 and the roller 224.

Each of the ribs 221 is a thin plate member that supports the sheet S. A plurality of the ribs 221 is disposed on the outer circumference of the movement belt 200 in the movement direction thereof at a predetermined interval. In the embodiment, in this manner, six columns of ribs 221 that are aligned in the movement direction are disposed on the movement belt 220.

In this configuration, when the roller 223 and the roller 224 are rotated in a predetermined direction (for example, counterclockwise) by the controller 60, the belt 220 is also rotated in the same direction (counterclockwise). According to the rotation of the belt 220, the six columns of ribs 211 disposed on the belt 220 are also moved.

### Printing Method of Third Embodiment

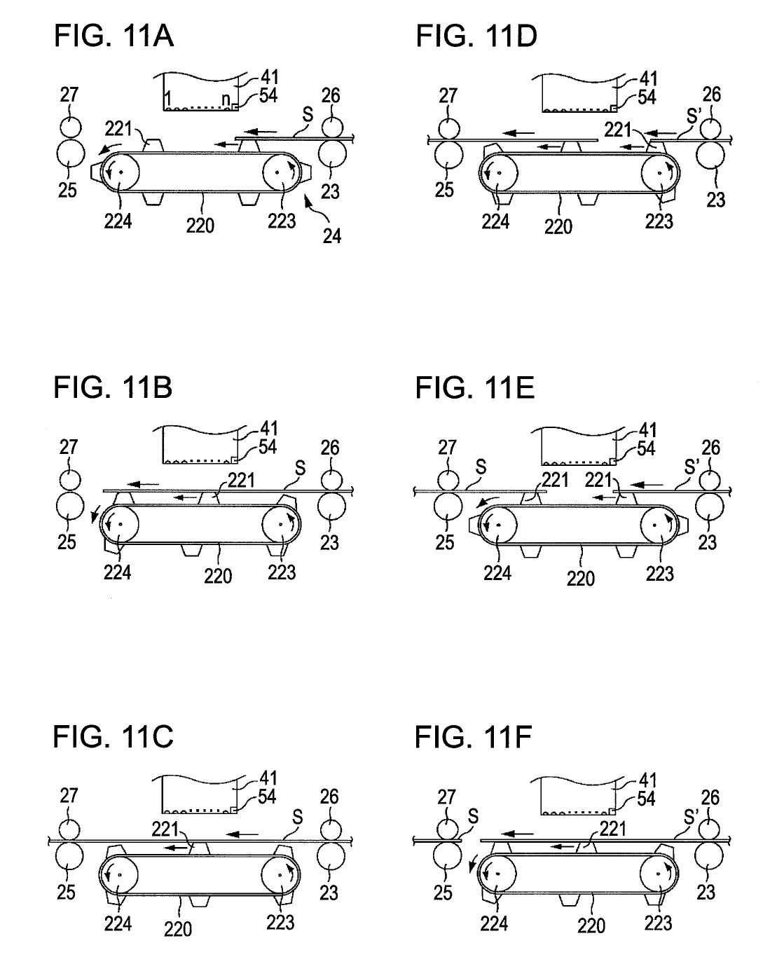

FIGS. 11A to 11F are views for explaining a printing method according to the third embodiment.

At the time of starting the printing, the rib 221 is positioned at the transport-direction upstream side and the transport-direction downstream side in an upper portion of the movement belt 220.

Firstly, the sheet S fed by the feeding roller 21 is transported in the transport direction by the transporting roller 23. At this time, the optical sensor 54 detects the front end of the sheet S. From the time when the optical sensor 54 detects the front end of the sheet S, the controller 60 rotates the transporting roller 23 by a predetermined rotation amount. Therefore, as shown in FIG. 11A, the sheet S is transported to the position where the front end thereof slightly passes the transport-direction upstream side rib 221. Under the state, the dot forming operation (pass) by the reciprocating movement of the head unit 40 and the transporting operation for transporting the sheet S in the transport direction are alternately repeated, so that an image is printed on the sheet S.

In the first pass, in the state shown in FIG. 11A, the controller 60 forms the dots on the front end portion of the sheet S by using the nozzles (transport-direction upstream side nozzles) of the head 41 facing the sheet S. In addition, since the ink is ejected from only the transport-direction upstream side nozzles, the transport-direction downstream side rib 221 cannot be contaminated. After the first pass, the controller 60 rotates the transporting roller 23 to transport the sheet S in the transport direction (transporting operation). In addition, the controller 60 rotates the roller 223 and the roller 224 in the arrow direction shown in the figure in accordance with the transportation of the sheet S, so that the transport-direction upstream side rib 221 can be moved in the transport direction. In other words, the rib 221 is moved in the transport direction in the state where the front end of the sheet S is supported. At this time, the transport-direction downstream side rib 221 is also moved in the arrow direction shown in the figure.

In the second pass, the controller 60 forms the dots on the sheet S by using the nozzles of the head 41 facing the sheet S. In the second pass, the number of nozzles facing the sheet S according to the transportation amount of the sheet S in the transporting operation is larger than that of the first pass. That is, in the second pass, the number of nozzles that is larger than that of the first pass can be used. In addition, in the third embodiment, as the number of the nozzles of ejecting the ink is increased in the transport direction, the transport-direction downstream side rib 221 is moved in the arrow direction shown in the figure, so that the rib 221 cannot be contaminated with the ink. After the second pass, the controller 60 also rotates the transporting roller 23 to transport the sheet S in the transport direction (transporting operation). In addition, at the time of the transporting operation for the sheet S, the controller 60 rotates the roller 223 and the roller 224 in the arrow direction shown in the figure to move the transport-direction upstream side rib 221 in the transport direction in accordance with the transportation of the sheet S. In other words, the transport-direction upstream side rib 221 supporting the front end of the sheet S is moved in the transport direction.

Next, the pass and the transporting operation (and the movement of the rib 221) are alternately repeated. Every time when the transporting operation is performed, the rib 221 supporting the sheet S is moved in the transport direction. Therefore, every time when the pass proceeds, the number of available nozzles (nozzles facing the sheet S) is increased in the transport direction.

As shown in 11B, when all the nozzles of the head 41 face the sheet S, the all nozzles of the head 41 can be used, so that the number of available nozzles is maximized. In addition, when the pass and the transporting operation are alternately repeated, as shown in FIG. 11C, the sheet S is transported by the transporting roller 23 and the discharging roller 25.

Next, if the rear end of the sheet S is detected by the sheet detecting sensor 53 in any one of the transporting operations, the controller 60 immediately rotates the feeding roller 21 and starts to transport the next sheet S′. At this time, an interval between the rear end of the preceding transported sheet S and the front end of the following transported sheet S′ is set to be smaller than the interval between the columns of the ribs 221. In addition, the preceding transported sheet S is transported only by the discharging roller 25, and the following transported sheet S′ is transported only by the transporting roller 23.

In addition, if the rear end of the sheet S (or the front end of the sheet S′) is detected by the optical sensor 54, as shown in FIG. 11D, the controller 60 rotates the transporting roller 23 and the discharging roller 25 by predetermined rotation amounts in the next transporting operation, so that the sheet S and the sheet S′ are transported in the transport direction. In addition, the controller 60 rotates the roller 223 and the roller 224 in the arrow direction shown in the figure in accordance with the transportation of the sheet S and the sheet S′, so that the rib 221 can be moved.

Therefore, as shown in FIG. 11D, the sheet S is transported by the discharging roller 25 at the position where the rear end thereof reaches slightly before the transport-direction substantially-central rib 221, and the sheet S′ is transported by the transporting roller 23 at the position where the front end thereof slightly passes the transport-direction upstream side rib 221.

In this manner, when the printing is performed on the rear end of the sheet S, the controller 60 positions the front end of the next sheet S′ under the head 41. Next, under the state, the pass for forming dots on the sheet S and the sheet S′ and the transporting operation for transporting the sheet S and the sheet S′ in the transport direction are repeatedly performed. In the pass, the dots are formed on the rear end of the sheet S by the nozzles of the head 41 facing the sheet S, and at the same time, the dots are formed on the front end of the sheet S′ by the nozzles of the head 41 facing the sheet S′. In addition, in the transporting operation, as shown in FIGS. 11D and 11E, the controller 60 moves the ribs 221 supporting the sheet S and the sheet S′ in the transport direction in accordance with the transportation of the sheet S and the sheet S′ in the transport direction. In other words, the rib 221 supporting the sheet S supports the rear end of the sheet S and is moved in the transport direction, and the rib 221 supporting the next sheet S′ supports the front end of the sheet S′ and is moved in the transport direction. Every time when the transporting operation is performed, since the sheet S and the sheet S′ are transported in the transport direction, the number of nozzles facing the sheet S is decreased. On the contrary, the number of nozzles facing the sheet S′ is increased. Therefore, every time when the pass proceeds, the number of nozzles for forming dots on the sheet S is decreased, and the number of nozzles for forming dots on the sheet S′ is increased. Therefore, in terms of the entire head 41, the substantially constant number of nozzles can be used for each pass.

Next, as shown in FIG. 11F, the printing for the sheet S is ended, and the sheet S is transported (discharged) outside the printer 1 by the discharging roller 25. In addition, the sheet S′ supported by the rib 221 is transported in the transport direction. Next, the same printing as that of the sheet S is performed on the sheet S′.

In this manner, even in a case where a plurality of the ribs is moved at one time, the one rib supporting the rear end of the sheet S is moved in the transport direction, and at the same time, the other rib supporting the front end of the next sheet S′ is moved in the transport direction. Therefore, since the printing can be performed in the state where the sheet S and the sheet S′ reach each other as close as possible, the printing time can be reduced. In addition, even in this case, the printing can be performed on the rear end of the sheet S and the front end of the sheet S′ simultaneously. Accordingly, the printing time can be reduced.

### Fourth Embodiment

In the aforementioned embodiments, the invention is adapted to a printer that forms dots on the sheet S by alternately repeating the reciprocating movement (pass) of the head unit 40 and the transportation of the sheet S. However, in a fourth embodiment, the invention is adapted to a printer (line printer) that is provided with a head having a length larger than a sheet width and forms dots on the sheet S by transporting the sheet S in the transport direction.

### Configuration of Printer

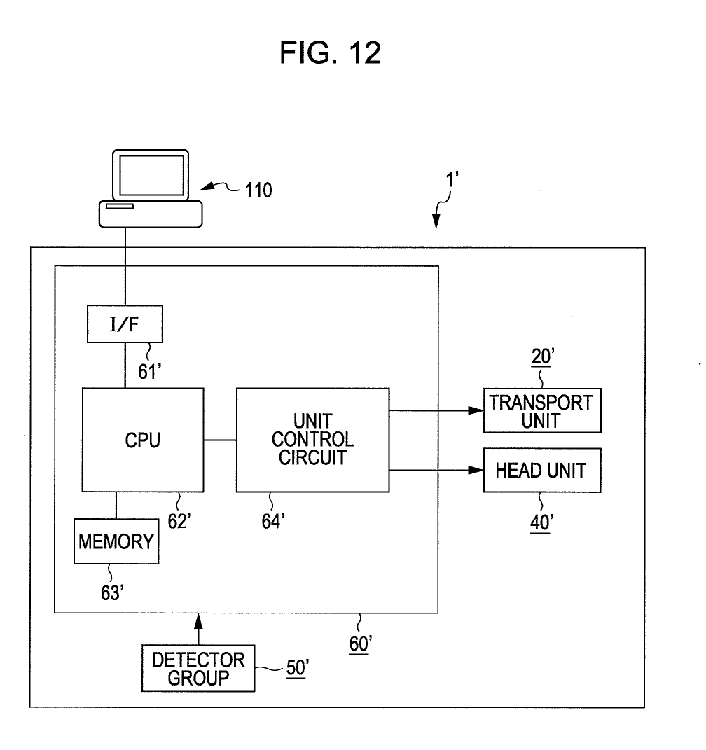

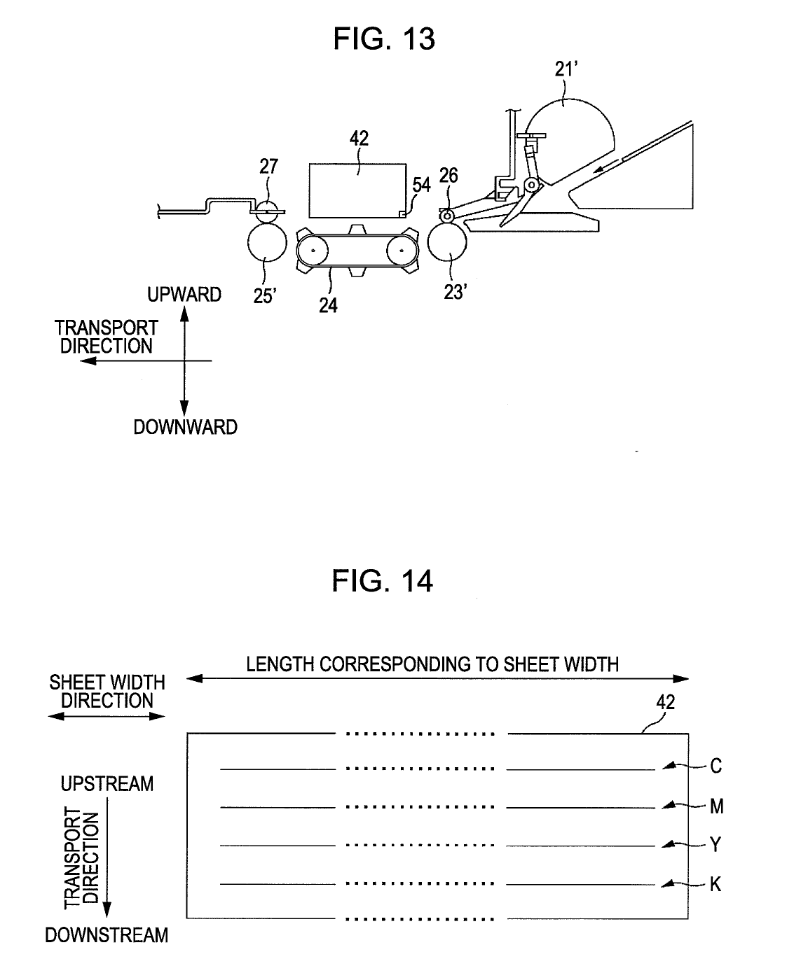

FIG. 12 is a block diagram illustrating a whole configuration of a printer 1′ according to a fourth embodiment. FIG. 13 is a transverse cross-sectional view illustrating the printer 1′ according to the fourth embodiment.

The printer 1′ includes a transport unit 20′, a head unit 40′, a detector group 50′, and a controller 60′. When the printer 1′ receives a printing command and a printing data from a computer 110 that is an external apparatus, the printer 1′ allows the controller 60′ to control each unit (the transport unit 20′ and the head unit 40′). The printer 1′ prints an image on a medium (for example, a sheet S) based on the printing data received from the computer 110. The status of the printer 1′ is monitored by the detector group 50′. The detector group 50′ outputs a result of the detection to the controller 60′. The controller 60′ controls each unit based on the result of the detection output from the detector group 50′.

The transport unit 20′ transports the sheet S to the printable position. At the time of the printing, the transport unit 20′ transports the sheet in the transport direction S at a predetermined transporting speed. The transport unit 20′ includes a feeding roller 21′, a transporting roller 23′, a platen 24, and an discharging roller 25′. The feeding roller 21′ is a roller for feeding the sheet S inserted into a sheet inserting opening into the printer. The transporting roller 23′ (corresponding to a first roller) is a roller for transporting the sheet S fed by the feeding roller 21′ at a predetermined transporting speed. The transporting roller 23′ is driven by a transporting motor (not shown). The platen 24 supports the sheet S during the printing thereof. The platen 24 is disposed under a head 42 described later. A lengthwise direction length of the platen 24 is designed to be longer than a sheet width of the transportable sheet S. The platen 24 according to the fourth embodiment is designed to have the same configuration as that of the platen 24 according to the third embodiment, and the description thereof is omitted. The discharging roller 25′ (corresponding to a second roller) is a roller for discharging the sheet S at a predetermined transporting speed outside the printer. The discharging roller 25′ is provided at the transport-direction downstream side with respect to the printable area. The discharging roller 25′ is rotated in synchronization with the transporting roller 23′. In addition, rotations of the feeding roller 21, the transporting roller 23′, and the discharging roller 25′ are controlled by the controller 60′.

When the sheet S is transported by the transporting roller 23′, the sheet S is interposed between the transporting roller 23′ and the driven roller 26. Therefore, the posture of the sheet S can be stabilized. In addition, when the sheet S is transported by the discharging roller 25′, the sheet S is interposed between the discharging roller 25′ and the driven roller 27′. Therefore, the posture of the sheet S can be stabilized.

The head unit 40′ is used to eject the ink on the sheet S. The head unit 40′ has a head 42. The head 42 ejects the ink on the sheet S during the transportation thereof so as to form the dots on the sheet S, so that an image is printed on the sheet S. The printer 1′ according to the embodiment is a line printer, in which the head 42 can form the dots corresponding to the sheet width at one time. The configuration of the head 42 is described later.

The status of the printer 1′ is monitored by a detector group 50′, which includes a rotary encoder 52, a sheet detecting sensor 53, and an optical sensor 54. The rotary encoder 52 detects a rotation amount of the transporting roller 23. The sheet detecting sensor 53 detects the front end (transport-direction downstream side end portion) and the rear end (transport-direction upstream side end portion) of the sheet S during the feeding thereof. The optical sensor 54 detects existence of the sheet S by using a light-emitting portion and a light-receiving portion which are disposed to the head 42. In addition, the optical sensor 54 can detect the front end and the rear end of the sheet S according to the status.

The controller 60′ is a control unit for controlling the printer 1′. The controller 60′ includes an interface unit 61′, a CPU 62′, a memory 63′, and a unit control circuit 64′. The interface unit 61′ performs data communication between the computer 110 (an external apparatus) and the printer 1′. The CPU 62′ is an arithmetic processing unit for controlling the entire portion of the printer 1′. The memory 63′ is used for securing an area for storing or executing programs of the CPU 62′. The memory 63′ includes storage devices such as an RAM and an EEPROM. The CPU 62′ allows the unit control circuit 64′ to control each of the units according to the programs stored in the memory 63′.

In addition, in the modified example of the third and fourth embodiments, after the printing for the rear end of the sheet S is ended and the sheet S is moved out from the printable area to the transport-direction downstream side, the next sheet S′ is transported to the printable area. In this case, a distance between a plurality of ribs may be set so that the two sheets S and S′ are transported at a predetermined distance that is a distance between the sheet S and the next sheet S′ that is larger than a transport direction distance of the nozzle columns, and the sheet S and the next sheet S′ are supported by the ribs.

### Configuration of Head Unit

The head unit 40′ according to the embodiment has the head 42.

FIG. 14 is a view for explaining an array of a plurality of nozzle columns on a lower surface of the head 42, as viewed in perspective from an upper side. Four nozzle columns are disposed on a lower surface of the head 42. The four nozzle columns are a cyan (C) ink nozzle column, a magenta (M) ink nozzle column, a yellow (Y) ink nozzle column, and a black (K) ink nozzle column in the order from the transport-direction upstream side. A sheet width direction length of each nozzle column is equal to or larger than a sheet width direction length of a to-be-printed sheet S.

In each nozzle column, a plurality of nozzles is aligned at a predetermined nozzle pitch in the sheet width direction.

### Printing Procedure

When receiving printing commands and printing data from the computer 110, the controller 60′ analyzes details of various kinds of commands included in the printing data and performs the following processes by using each unit.

Firstly, the controller 60′ rotates the feeding roller 21 to transport a to-be-printed sheet S to the transporting roller 23′. Next, the controller 60 drives a transporting motor (not shown) to rotate the transporting roller 23′. When the transporting roller 23 is rotated at a predetermined rotating speed, the sheet S is transported in the transport direction at a predetermined speed.

Therefore, the sheet S is transported on the platen 24 at a constant speed without stopping thereof. Next, when the sheet S sequentially passes lower portions of the nozzle columns of the head 42, the ink is intermittently ejected from the nozzles of the head 42 according to instructions of the controller 60. As a result, dot columns constructed with a plurality of dots is formed on the sheet S in the transport direction and the sheet width direction. In addition, the controller 60′ rotates the discharging roller 25′ in synchronization with the transporting roller 23′. Therefore, the sheet S on which the dots are formed are transported outside the printer 1′.

### Printing Method of Fourth Embodiment

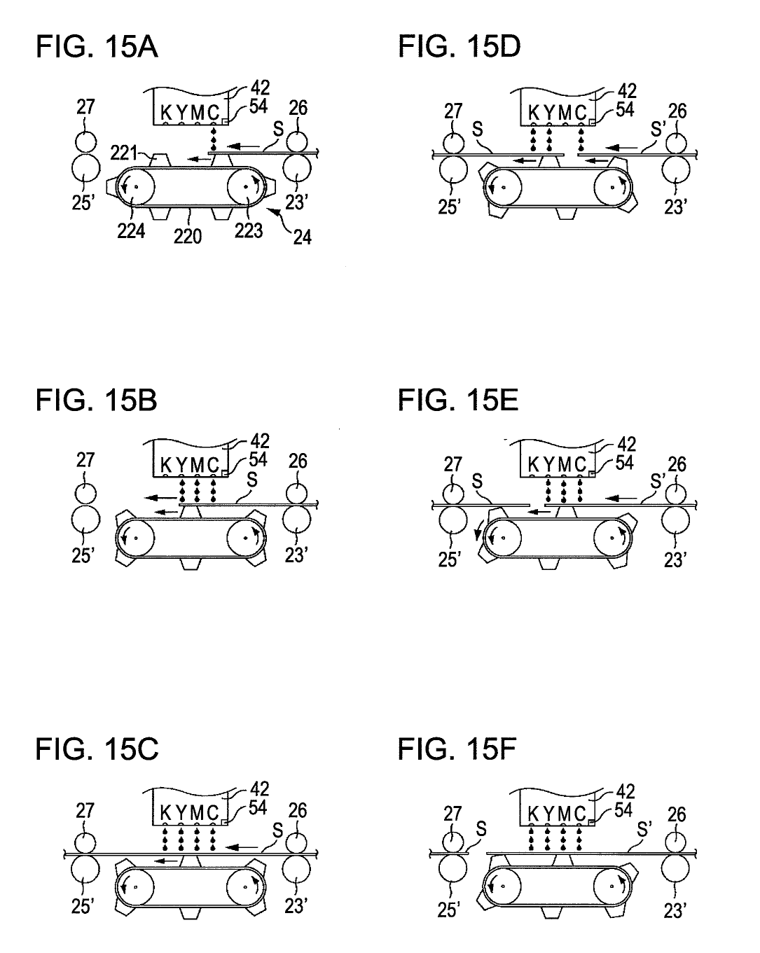

FIGS. 15 A to 15 F are views for explaining a printing method according to the fourth embodiment.

At the time of starting the printing, the ribs 221 are positioned at the transport-direction upstream side and the transport-direction downstream side of the upper portion of the movement belt 220.

Firstly, the sheet S fed by the feeding roller 21′ is transported in the transport direction at a predetermined transporting speed by the transporting roller 23′. At this time, the optical sensor 54 detects the front end of the sheet S. After the elapse of a predetermined time from the time when the optical sensor 54 detects the front end of the sheet S, the controller 60′ rotates the roller 223 and the roller 224 in the arrow direction of FIG. 15A. At the time, the front end of the sheet S slightly passes the transport-direction upstream side rib 221, and the rib 221 is moved in the transport direction in accordance with the movement of the sheet S. In other words, the rib 221 supporting the front end of the sheet S is moved in the transport direction. As the sheet S is moved in the transport direction, the ink is sequentially ejected from each nozzle column of the head 42 facing the sheet S.

In addition, in the embodiment, the printer 1′ performs printing (so-called board-less printing) of forming no margin on the sheet S. For example, just before the front end the sheet S reaches a lower portion of the cyan ink nozzle column, the ink is ejected from the cyan ink nozzle column. Therefore, the cyan ink lands on the front end of the sheet S. The ink that does not land on the sheet S lands on the belt 200, so that the rib 221 cannot be contaminated.

In addition, in FIG. 15B, the front end of the sheet S reaches the magenta ink nozzle column and the yellow ink nozzle column. In this case, just before the front end of the sheet S reaches a lower portion of the magenta ink nozzle column, the ink is ejected from the magenta ink nozzle column. In addition, just before the front end of the sheet S reaches a lower portion of the yellow ink nozzle column, the ink is ejected from the yellow ink nozzle column. Therefore, the magenta ink and the yellow ink land on the front end of the sheet S. The ink that does not land on the sheet S lands on the belt 200, so that the rib 221 cannot be contaminated. When the sheet S reaches the black ink nozzle column, the same operation is performed. In this manner, every time when the transportation of the sheet S proceeds, the number of available nozzles (nozzle columns) is increased. When all the nozzle columns of the head 42 face the sheet S, all the nozzle columns can eject the ink. At this time, the number of available nozzles is maximized.

When the transportation of the sheet S further proceeds, as shown in FIG. 15C, the sheet S is transported by the transporting roller 23′ and the discharging roller 25′. Next, when the sheet S is further transported in the transport direction, the dots are formed by ejecting the ink from the nozzle columns of the head 42. In addition, the rib 221 is moved in accordance with the transportation of the sheet S.

Next, if the rear end of the sheet S is detected by the sheet detecting sensor 53, the controller 60′ immediately rotates the feeding roller 21′ and starts to transport the next sheet (refer to as a sheet S′). At this time, an interval between the rear end of the preceding transported sheet S and the front end of the following transported sheet S′ is set to be smaller than the interval between the columns of ribs 221 on the circumference of the movement belt 220.

In addition, if the rear end of the sheet S (or the front end of the sheet S′) is detected by the optical sensor 54, after the elapse of a predetermined time, the controller 60′ rotates the roller 223 and the roller 224 in the arrow direction. Therefore, the sheet S is transported slightly before the position where the rear end thereof reaches the transport-direction substantially-central rib 211, and the sheet S′ is transported to the position where the front end thereof slightly passes the transport-direction upstream side rib 221. Next, the controller 60′ moves the transport-direction substantially-central rib 221 in the transport direction in accordance with the transportation of the sheet S. In addition, the controller 60′ moves the transport-direction upstream side rib 221 in the transport direction in accordance with the transportation of the sheet S′. In other words, the transport-direction substantially-central rib 221 supporting the rear end of the sheet S is moved in the transport direction, and the transport-direction upstream side rib 221 supporting the front end of the sheet S′ is moved in the transport direction. In addition, as shown in FIGS. 15D and 15E, the controller 60′ forms the dots on the rear end of the sheet S by using the transport-direction downstream side nozzles (for example, the black nozzle column or the yellow nozzle column) of the head 42 facing the sheet S. In addition, the controller 60′ forms the dots on the front end of the sheet S′ by using the transport-direction upstream side nozzles (for example, the cyan nozzle column or the magenta nozzle column) of the head 42 facing the sheet S′. That is, the printing is simultaneously performed on the rear end of the preceding transported sheet S and the front end of the following transported sheet S′.

Every time when the transportation of the sheet S and the sheet S′ proceeds, as shown in FIG. 15D, the number of nozzles (nozzle columns) for ejecting the ink on the sheet S is decreased, and the number of nozzles (nozzle columns) for ejecting the ink on the sheet S′ is increased.

Next, as shown in FIG. 15F, the printing is ended, and the sheet S is transported (discharged) outside the printer 1′. In addition, similarly to the front end, the board-less printing is performed on the rear end of the sheet S. In addition, the sheet S′ is transported in the transport direction by the transporting roller 23, and all the nozzle columns are used for the printing. Next, the same printing as that of the sheet S is performed on the sheet S′.

In this manner, the one rib 221 supporting the rear end of the sheet S is moved in the transport direction, and at the same time, the other rib 221 supporting the front end of the sheet S′ is moved in the transport direction. Therefore, since the printing can be performed in the state where the sheet S and the sheet S′ reach each other as close as possible, the printing time can be reduced. In addition, when the printing is performed on the rear end of the sheet S, the controller 60′ positions the front end of the sheet S′ under the head 42. Next, the printing is simultaneously performed on the rear end of the sheet S and the front end of the sheet S′ by using the nozzle columns facing the head 42. Accordingly, the printing time can be reduced.

In addition, in the embodiment, when the rear end of the sheet S is detected by the sheet detecting sensor 53, the feeding roller 21′ is rotated. However, since the transporting speed of the sheet S is constant, the feeding roller 21 may be rotated in a constant period. Therefore, an interval between the rear end of the preceding transported sheet S and the front end of the following transported sheet S′ can be easily controlled.

In addition, in the fourth embodiment, the platen 24 according to the third embodiment is used for the platen 24. However, the platens 24 according to the first and second embodiments may be used.

### Fifth Embodiment

In the head 42 according to the fourth embodiment, four nozzle columns are formed to have a shape of straight line. In this case, since the transport direction length of the head is shortened, the controlling of the nozzles used according to the transportation of the sheet S may be difficult. However, in the fifth embodiment, a plurality of tips that ejects the same ink is arrayed in a zigzag manner, the transport direction length of the head can be larger than that of the fourth embodiment. In a case of a head where a plurality of kinds of ink can be ejected by one tip or a case where the printing is performed by only one kind of ink, one line of tips arrayed in a zigzag manner may be used. In addition, a positional relationship between a plurality of the tips is not limited to the zigzag array. An array capable of performing the printing across the width of medium during the transportation of the medium may be used. In addition, configurations except for the head are the same as those of the fourth embodiment.

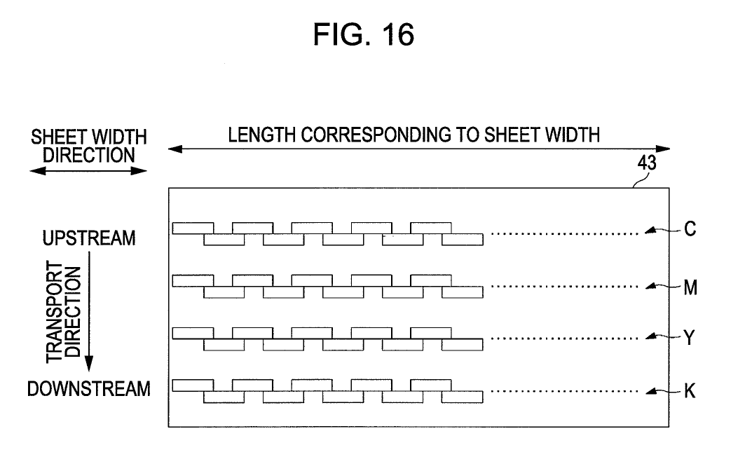

FIG. 16 is a view for explaining an array of a plurality of nozzle columns on a lower surface of the head 43 of the fifth embodiment, as viewed in perspective from an upper side. Four nozzle columns are disposed on a lower surface of the head 43. The four nozzle columns are a cyan (C) ink nozzle column, a magenta (M) ink nozzle column, a yellow (Y) ink nozzle column, and a black (K) ink nozzle column in the order from the transport-direction upstream side. A sheet width direction length of each nozzle column is equal to or larger than a sheet width direction length of a to-be-printed sheet S.

In addition, as shown in the figures, the nozzle columns of the head 43 are formed with a configuration where the tips 44 having a plurality of nozzles are arrayed in a zigzag manner in the sheet width direction. In this manner, in the head 43 according to the fifth embodiment, since the tips 44 are disposed to be aligned in a zigzag manner for each color, the transport direction length is enlarged. Therefore, the time required for the sheet S to pass the head 43 is increased, so that the timing of ejecting the ink from each nozzle column can be more easily controlled.

In addition, in the embodiment, the tips included in each nozzle column are arrayed in a zigzag manner. However, for example, independent heads including multi-color or single-color nozzle columns having a shape of straight line may be disposed to be aligned in the sheet width direction.

### Other Embodiments

In the aforementioned embodiments, printers are mainly disclosed. In the description, a printing apparatus, a recording apparatus, a liquid ejecting apparatus, a printing method, a recording method, a liquid ejecting method, a printing system, a recording system, a computer system, a program, a program storage medium, a display screen, a screen display method, a printed-object manufacturing method, and the like are also included in the disclosure.

In addition, a printer or the like are described as an embodiment. The embodiment is provided for the better understanding of the invention, but they are not provided for limiting and analyzing the invention. The invention can be changed and modified without departing from the spirit of the invention, and equivalents are included therein. Particularly, the later-described embodiments are also included in the invention.

### Printer

In the aforementioned embodiments, a printer is described, but the invention is not limited thereto. The technologies of the invention can be adapted to, for example, a color filter manufacturing apparatus, a dying apparatus, a micro-machining apparatus, a semiconductor manufacturing apparatus, a surface machining apparatus, a three-dimensional molding machine, a liquid vaporizing apparatus, an organic EL manufacturing apparatus (particularly, a polymer EL manufacturing apparatus), a display manufacturing apparatus, a film forming apparatus, a DNA chip manufacturing apparatus, or other kinds of recording apparatuses using an ink jet technique. In addition, these methods or manufacturing methods are included in the range of applications.

### Ink

In the aforementioned embodiments, since a printer is exemplified, a dying ink or a pigment ink is ejected form the nozzles. However, the liquid ejected from the nozzles is not limited to these inks. For example, a liquid (including water) including a metallic material, an organic material (particularly, a polymer material), a magnetic material, a conductive material, a metallization material, a film forming material, an electronic ink, a processing solution, a genetic solution, or the like may be ejected from the nozzles.

The entire disclosure of Japanese Patent Application No. 2008-215693, filed Aug. 25, 2008 is expressly incorporated by reference herein.

What is claimed is:

1. A liquid ejecting apparatus comprising:
a head that ejects a liquid on a medium positioned in a printable area;
a transporting unit that transports a first medium and a second medium successively in a transport direction;
a first supporting member that supports a transport-direction upstream side end portion of the first medium and moves in the transport direction according to transportation of the first medium; and
a second supporting member that supports a transport-direction downstream side end portion of the second medium and moves in the transport direction according to transportation of the second medium.

2. The liquid ejecting apparatus according to claim 1, wherein the first supporting member supports the first medium, and the second supporting member supports the second medium.

3. The liquid ejecting apparatus according to claim 1, further comprising a detecting unit that detects an end portion of each medium,
wherein the transport-direction downstream side end portion of the second medium is detected by the detecting unit during the printing for the first medium.

4. The liquid ejecting apparatus according to claim 1,
wherein the transporting unit includes:
a first roller that transports the medium at the transport-direction downstream side with respect to the printable area; and
a second roller that transports the medium at the transport-direction upstream side with respect to the printable area, and
wherein, when the first supporting member supports the transport-direction upstream side end portion of the first medium and when the second supporting member supports the transport-direction downstream side end portion of the second medium, the first medium is transported by the first roller, and the second medium is transported by the second roller.

5. The liquid ejecting apparatus according to claim 1, wherein, while the second supporting member supports the second medium, the first supporting member moves to the transport-direction upstream side.

6. The liquid ejecting apparatus according to claim 1, wherein, when the head does not eject the liquid, the first supporting member moves to the transport-direction upstream side to support the second medium.

7. The liquid ejecting apparatus according to claim 1,
wherein the head includes a first nozzle and a second nozzle,
wherein the second nozzle is disposed at the transport-direction upstream side with respect to the first nozzle, and
wherein, when the head forms dots on the transport-direction upstream side end portion of the first medium by using the first nozzle, the transport-direction downstream side end portion of the second medium is positioned in the printable area, and the head forms dots on the transport-direction downstream side end portion of the second medium by using the second nozzle.

8. A liquid ejecting method comprising:
transporting a first medium and a second medium successively in a transport direction;
supporting a transport-direction upstream side end portion of the first medium by using a first supporting member, and supporting a transport-direction downstream side end portion of the second medium by using a second supporting member;
moving the first supporting member in the transport direction according to transportation of the first medium, and moving the second supporting member in the transport direction according to transportation of the second medium; and
ejecting liquid on each medium positioned in a printable area.

9. The liquid ejecting apparatus according to claim 1, further comprising a detecting unit that detects an end portion of each medium,
wherein the first supporting member supports the first medium, and the second supporting member supports the second medium,
wherein the transport-direction downstream side end portion of the second medium is detected by the detecting unit during the printing for the first medium,
wherein the transporting unit includes:
a first roller that transports the medium at the transport-direction downstream side with respect to the printable area; and
a second roller that transports the medium at the transport-direction upstream side with respect to the printable area,
wherein, when the first supporting member supports the transport-direction upstream side end portion of the first medium and when the second supporting member supports the transport-direction downstream side end portion of the second medium, the first medium is transported by the first roller, and the second medium is transported by the second roller,
wherein, while the second supporting member supports the second medium, the first supporting member moves to the transport-direction upstream side,
wherein, when the head does not eject the liquid, the first supporting member moves to the transport-direction upstream side to support the second medium,
wherein the head includes a first nozzle and a second nozzle,
wherein the second nozzle is disposed at the transport-direction upstream side with respect to the first nozzle, and
wherein, when the head forms dots on the transport-direction upstream side end portion of the first medium by using the first nozzle, the transport-direction downstream side end portion of the second medium is positioned in the printable area, and the head forms dots on the transport-direction downstream side end portion of the second medium by using the second nozzle.
